(19) United States
(12) Patent Application Publication
(10) Pub. No.: US 2009/0078134 A1
(43) Pub. Date: Mar. 26, 2009

(54) Flexographic Printing Press

(76) Inventors: Ewald Rothlein, Retzstadt (DE); Georg Schneider, Wurzburg (DE)

Correspondence Address: JONES, TULLAR & COOPER, P.C., P.O. BOX 2266 EADS STATION, ARLINGTON, VA, 22202, US

(21) Appl. No.: 11/920,408

(22) PCT Filed: Jun. 8, 2006
(86) PCT No.: PCT/EP2006/063027

§ 371 Date: Nov. 15, 2007

(30) Foreign Application Priority Data
Jun. 17, 2005 (DE) 10 2005 028 424.8
Jul. 7, 2005 (DE) 10 2005 032 120.8
Aug. 18, 2005 (DE) 10 2005 039 074.9
Jan. 23, 2006 (DE) 10 2006 003 013.3

(51) Int. Cl. B41F 31/00

(52) U.S. Cl. 101/141

(57) ABSTRACT

A flexographic printing press is comprised of at least four printing cylinders which are each driven by a respective drive motor. These at least four printing cylinders cooperate directly with a common satellite cylinder during the printing of a web of material. Each of these printing cylinders supports at least one flexographic printing plate. Each end journal of such printing cylinder is mounted in at least one linear bearing that is located on a lateral frame, and which can be moved perpendicularly to the axis of rotation of the respective cylinder. A stator of each driving motor can be moved along with the associated linear bearing, or along with the printing cylinder. Each such drive motor is configured as a synchronous motor which is excited by a permanent magnet. An independent hydraulic actuator is assigned to each printing cylinder, to change the position of that printing cylinder. At least one linear bearing is arranged in a bearing unit which is placed on the interior wall of the respective lateral frame. The journals of each printing cylinder do not penetrate the lateral frames.

### CROSS-REFERENCE TO RELATED APPLICATIONS

This application is the U.S. national phase, under 35 USC 371, of PCT/EP2006/063027, filed Jun. 8, 2006; published as WO 2006/134070 A2 and A3 on Dec. 21, 2006 and claiming priority to DE 10 2005 028 424.8, filed Jun. 17, 2005; to DE 10 2005 032 120.8, filed Jul. 7, 2005; to DE 10 2005 039 074.9, filed Aug. 18, 2005 and to DE 10 2006 003 013.3, filed Jan. 23, 2006, the disclosures of which are expressly incorporated herein by reference.

### FIELD OF THE INVENTION

The present invention is directed to a flexographic printing press. The flexographic printing press has at least one forme cylinder, which is driven by its own electric motor. At least one flexographic printing plate is carried on the at least one forme cylinder.

### BACKGROUND OF THE INVENTION

An arrangement for inking a roller of a printing group is known from WO 03/047864 A2 and which is usable in connection with an inking system for a printing group of a double-width printing press. Either two doctor blades, which are arranged side-by-side in the axial direction of the roller, or one doctor blade of a length of at least four side-by-side arranged newspaper pages, can be independently placed against the roller or moved away from the roller.

EP 1 435 292 A1 discloses a printing unit with a satellite cylinder, with which satellite cylinder, four plate cylinders work together. Each one of the plate cylinders supports four flexographic printing plates in the axial direction. Each one of the plate cylinders is arranged in eccentric bearings.

DE 101 03 631 A1 describes a flexographic printing press, whose plate cylinders are seated in linear guides.

DE 10 2004 001 467 A1, EP 1 082 225 B1, DE 101 23 138 A1 and DE 102 51 977 A1 all describe electric motors with permanent magnets.

### SUMMARY OF THE INVENTION

The object of the present invention is directed to providing a flexographic printing press.

In accordance with the invention, the object is attained by the provision of at least one forme cylinder that is driven by its own motor and which carries at least one flexographic printing plate. The motor for each such forme cylinder may be an angular position-regulated electric motor. Four such forme cylinders may directly work with a satellite cylinder. Journals of each forme cylinder are seated in linear bearings arranged in lateral frames of the printing press. Each forme cylinder can be moved, together with a stator of its associated drive motor.

The advantages to be gained with the present invention consist, in particular, in that a press is provided, which is easy to produce, or to operate, which is comparatively spatially compact, and which makes possible a high printing quality.

An ideal installation position of the cylinders or rollers, in respect to limiting or eliminating possible cylinder vibrations, is achieved by the employment of linear guides for the forme cylinders and screen rollers of the printing groups. In addition, short adjustment paths are accomplished by the cylinder seating, and therefore no synchronizing spindle is required. The expensive installation of three-ring bearings is unnecessary.

The use of a synchronous motor and/or of a drive mechanism, with excitation by a permanent magnet as the drive motor for the printing group cylinders or the screen roller, provides a particularly simple, and yet strong drive mechanism for these rotating bodies.

A dryer is arranged in such a way that the waste heat from the dryer again dries a paper web running over it. Accordingly, the time required for drying, or the path required for drying, is shortened.

An additional advantage is provided because of the coupling of the chamber doctor blade with the linear bearing of the screen roller. It is advantageous, in connection with a hydraulic engagement of the doctor blade system, in contrast to a pneumatic engagement, that the hydraulic pressure column is not compressible. However, it is disadvantageous with this embodiment, that a rapid disengagement of the doctor blade chamber from the screen roller is not possible in the case of a required position change of the screen roller, for example because of a paper rip. By use of the coupling with the linear carriage of the screen roller, which is provided in accordance with the present invention, this disadvantage is avoided.

In accordance with further embodiments of the present invention, it is possible to print at variable section lengths, from which a particularly efficient possibility for operating the flexographic printing press results.

In accordance with a further aspect of the present invention, it is contemplated to clear the surface of a screen roller, by suction, prior to the entry of the screen roller into the chamber doctor blade. Because of this, the print quality, in particular, of the press can be improved and dirt accumulation can be reduced.

In accordance with a further aspect of the present invention, the possibility is provided of making the imprinting of paper webs of different widths possible in a simple manner.

### BRIEF DESCRIPTION OF THE DRAWINGS

Preferred embodiments of the present invention are represented in the drawings and will be described in greater detail in what follows.

Shown are in:

FIG. 1, a schematic side elevation view of a flexographic printing press in accordance with the present invention, with two side-by-side arranged printing towers, each with two satellite printing units arranged on top of each other, in

FIG. 2, a schematic side elevation view of a printing tower of a flexographic printing press in accordance with FIG. 1, in

FIG. 3, a longitudinal section through a bearing unit of a cylinder of a printing group of a flexographic printing press, in

FIG. 4, a cross section through a bearing unit in accordance with FIG. 3, in

FIG. 5, a detail from FIG. 3 in an enlarged representation, in

FIG. 6, a drive motor, embodied as a synchronous motor and/or as a motor excited by a permanent magnet, of a cylinder or a roller of a flexographic printing press, in

FIG. 7, a further embodiment of a drive motor, in

FIG. 8, a further embodiment of a drive motor, in

FIG. 9, a further embodiment of a drive motor, in

FIG. 10, a further embodiment of a drive motor, in

FIG. 11, a lateral view of a forme cylinder with a linear bearing, in

FIG. 12, a view, from above, on a mechanical coupling of the linear bearing of a chamber doctor blade with the linear bearing of a screen roller in the engaged position of the chamber doctor blade, in

FIG. 13, a view, from above, corresponding to FIG. 12, but in the disengaged state of the chamber doctor blade, in

FIG. 14, a coupling between the screen roller and the chamber doctor blade in an engaged position and in a view perpendicularly to that in accordance with FIG. 12, in

FIG. 15, the coupling in accordance with FIG. 14, but in the disengaged state, in

FIG. 16, a view from above of a cylinder group consisting of a satellite cylinder, forme cylinder and chamber doctor blade, in

FIG. 17, a lateral view of a flexographic printing group in a first state of the setting of a zero position, in

FIG. 18, a lateral view of a flexographic printing group in accordance with FIG. 14 in a second state of the setting of a zero position, in

FIG. 19, a lateral view of a further embodiment of a satellite printing unit in accordance with the present invention with horizontal parallel linear guide devices, in

FIG. 20, a lateral view of a further embodiment of a satellite printing unit with vertical lower linear guide devices, in

FIG. 21, a view from above of a mechanical coupling of the linear bearing of the chamber doctor blade with the linear bearing of the screen roller in connection with the embodiment in accordance with FIG. 20, in

FIG. 22, a lateral view of a further preferred embodiment of a satellite printing unit in accordance with the present invention, with eight forme cylinders, in

FIG. 23, a further embodiment of a linear bearing in accordance with the present invention, with two detent keys for a screen roller of a satellite printing unit in accordance with FIG. 22, in

FIG. 24, a lateral view of a further embodiment of a satellite printing unit which permits variable section lengths, in

FIG. 25, an illustration of a printing process by use of the satellite printing unit in accordance with FIG. 24, in

FIG. 26, a lateral view of a folding apparatus for employment in a flexographic printing press, in

FIG. 27, a second preferred embodiment of a folding apparatus for employment in a flexographic printing press in a lateral view, in

FIG. 28, a schematic representation of a cutting cylinder pair in accordance with FIG. 26 or 27, in

FIG. 29, a second embodiment of a cutting cylinder pair in accordance with FIG. 26 or 27, in

FIG. 30, a lateral view of a further embodiment of a satellite printing unit with suction devices for the screen rollers, in

FIG. 31, an enlarged lateral view of a screen roller in accordance with FIG. 30, and with a suction device, and in

FIG. 32, an enlarged view, from above, of a screen roller in accordance with FIG. 30 with a suction device.

### DESCRIPTION OF THE PREFERRED EMBODIMENTS

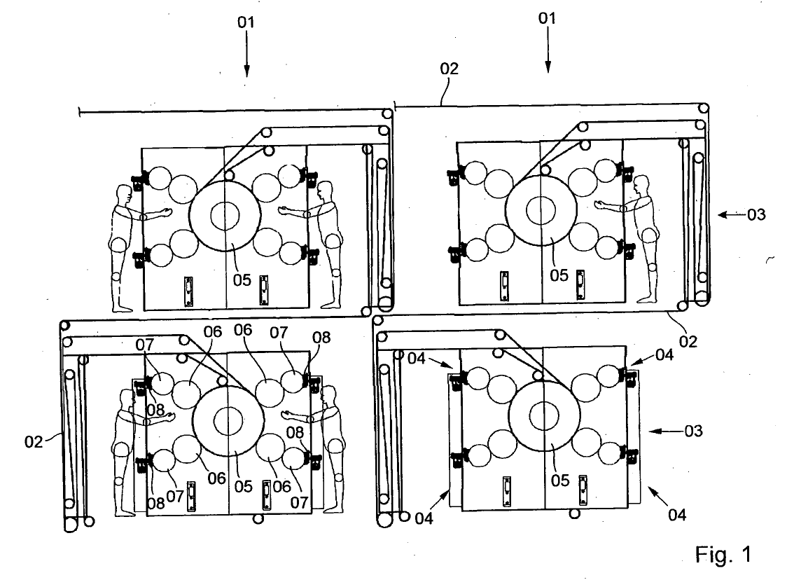

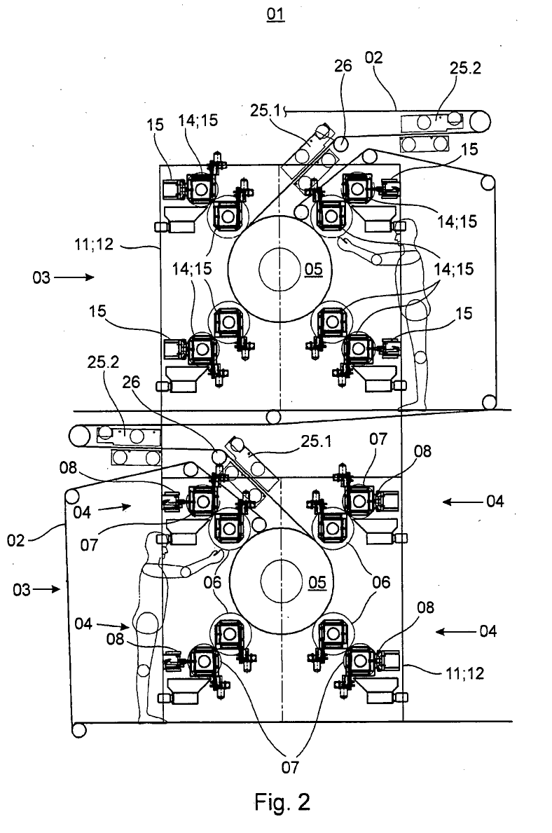

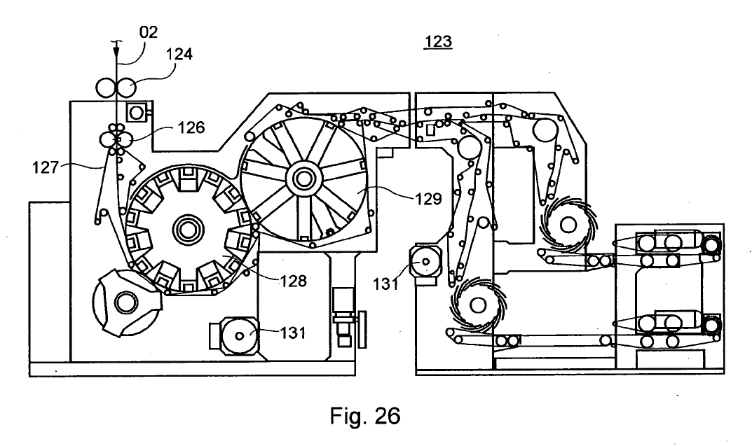

Referring initially to FIGS. 1 and 2, there may be seen a schematic representation of aflexographic printing press, which is not shown in further detail. The depicted flexographic printing press comprises several, such as, for example, two, side-by-side arranged printing towers 01, each of which printing towers 01 has several, and in particular has two, printing units 03, and in particular has two, satellite printing units 03, arranged on top of each other, and through which satellite printing units 03, imprint material webs 02, and in particular paper webs 02, are conducted for being imprinted on both sides in several colors. The printing towers 01 can be arranged on a machine pedestal, which is not specifically represented, and roll changers, which are also not specifically represented, can be arranged underneath the pedestal. Such roll changers supply the printing towers 01 with paper webs 02 in a generally conventional manner. The paper webs 02 pass through the printing towers 01 in a transport direction, from below the printing towers 01 to the top, above the printing towers 01. Imprinted paper webs 02, conducted out of the printing towers 01, can be brought together in a superstructure of the printing press, which is not specifically represented in FIG. 1, and can be conducted to one or to several processing stations such as, for example, a cutting station, as well as to one or to several follow-up processing stations such as, for example, a folding group 123, as may be seen in FIG. 26.

Each satellite printing unit 03 comprises a central cylinder 05, namely the satellite cylinder 05, which is used as a counter-pressure cylinder 05, as well as several, and preferably at least four, and in the case of the preferred embodiment, exactly four, printing groups 04, each of which printing groups 04 is arranged on the satellite cylinder 05. Each such printing group 04 is configured for letterpress printing, and in particular for flexographic printing. The general construction and the mode of functioning of flexographic printing groups 04 is generally known in the art, so that it is not necessary to address this construction and mode of operation here in detail. Therefore, for the sake of clarity, in the very schematic representation, in accordance with FIGS. 1 and 2, only the two cylinders 06, 07, namely the forme cylinder 06 resting against the satellite cylinder 05 and forming a printing gap together with it, and the screen roller 07, or the component 07, as well as the component 08 providing the screen roller 07 with printing ink, such as, for example, the chamber doctor blade 08, are schematically depicted.

The embodiment of the present invention, in accordance with FIG. 2, differs from the embodiment of the present invention, in accordance with FIG. 1, essentially only by the slightly different arrangement of the printing groups 04 against the satellite cylinder 06.

The flexographic printing press is, for example, configured for newspaper printing. Viewed in the axial direction of the cylinders 05, 06, 07, the width of the press is such that the forme cylinders 06 have at least two, and preferably have four, newspaper pages in the axial direction as the print image 29. Preferably, the diameter of the forme cylinders 06 has been selected in such a way that the forme cylinders 06 have four newspaper pages as the print image 29 in the circumferential direction. The barrel of the forme cylinder 06 can, in particular, have a circumference of 1,100 mm to 1,300 mm, and a length of 1,400 mm to 1,800 mm.

In the axial direction, the forme cylinders 06 each preferably support four flexographic printing plates, which are not specifically represented here side-by-side, and two flexographic printing plates one behind the other in the circumferential direction.

Preferably, the diameter of the satellite cylinder 05 is a whole number multiple, and in particular is three times, the diameter of the associated forme cylinders 06. However, it can also be advantageous to dimension the satellite cylinder 05 such that its diameter is, in particular 2.5, times the diameter of the associated forme cylinder 06. In accordance with a further aspect of the present invention, it is advantageous to dimension the circumference of the satellite cylinder 05 such, that it corresponds to a whole number multiple of the section length of a printed product which is printed or manufactured by the use of the flexographic printing press.

The forme cylinder 06, the screen roller 07 and the chamber doctor blade 08 of each one of the printing groups 04 are respectively arranged in such a way that they can be placed against the satellite cylinder 05 and can be moved away, and out of contact with the satellite cylinder 05. For this purpose, the forme cylinders 06, the screen rollers 07 and the chamber doctor blades 08 are seated in bearing units 14, as are depicted schematically in FIG. 2. These bearing units 14 include, in addition to a rotary bearing, also a linear bearing 15, such as will be extensively explained in what follows. Preferably, each forme cylinder 06, each screen roller 07 and each chamber doctor blade 08 is assigned its own respective linear bearing 15. The bearing units 14, or the linear bearings 15 of the forme cylinders 06 and of the screen rollers 07 on the one hand, and of the chamber doctor blades 08 on the other hand, can each be structurally configured differently in detail with respect to each other.

All of the cylinders 05, 06, 07, or in other words, the satellite cylinder 05, the forme cylinders 06 and the screen rollers 07, in particular, are each driven by their own drive motors 121, which are not specifically represented in FIGS. 1 and 2, which drive motors 121 can, in particular, be respective electric motors 121, whose angular position is regulated, and preferably can be configured as a synchronous motor 121 and/or as a drive motor 121 with excitation by a permanent magnet. A detailed description of the drive motors 121, which are preferably employed for such usage, will follow subsequently.

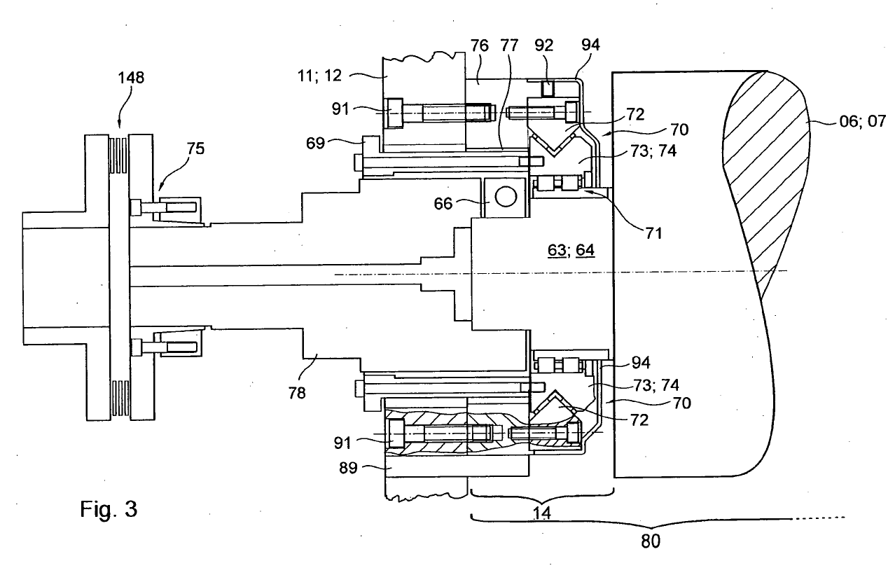

In the discussion which follows, and making specific reference to FIGS. 3 to 5, the bearing units 14, or the linear bearings 15, which can be used, in particular, for seating and for guiding the forme cylinders 06 and the screen rollers 07, will be described in greater detail with respect to their basic construction.

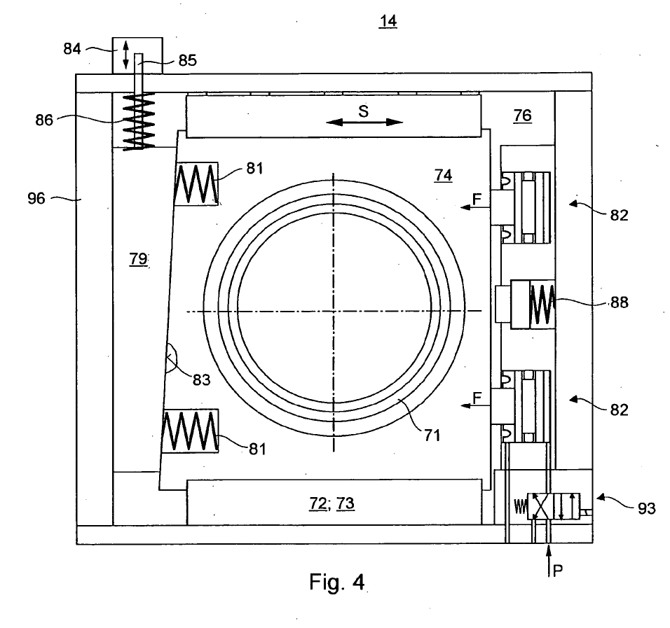

FIGS. 3 and 4 show a bearing unit 14, which is preferably based on providing linear actuating paths, in a schematic longitudinal section and a schematic cross section, respectively. The bearing unit 14 which integrates the contact mechanism has, a bearing 71, such as, for example, a radial bearing 71, and more particularly, such as, for example, a cylinder rolling bearing 71, for use to accomplish the rotatory seating and supporting of the cylinders 06, 07. Each bearing unit 14 also has bearings 72, 73 or bearing elements 72, 73 for use in accomplishing a radial movement of the cylinder 06, 07 for placing that respective cylinder 06, 07 into print-on or print-off positions. For this purpose, the bearing unit 14 has bearing elements 72, which are fixed on a support, following mounting of the bearing unit 14 fixed on the frame, as well as the bearing elements 73, which can be moved with respect to the fixed bearing elements 72. The fixed-on-the-support bearing elements 72 and the movable bearing elements 73 are embodied as cooperating linear bearing elements 72, 73 and, together with appropriate sliding faces or interposed rolling elements, are configured as a whole, as the linear guide 70, for example, as the linear bearing 70. Between themselves, the pairs of linear elements 72, 73 receive a bearing block 74, such as, for example, a carriage 74, which receives the radial bearing 71. The bearing block 74 and the movable bearing elements 73 can also be embodied in one piece. The bearing elements 72, which are fixed on the support, are arranged on a support 76, which will be, or which is connected, as a whole, with the lateral frame 11, 12 of a printing tower 01. For example, the support 76 may be configured as a support plate 76 which has, at least on a printing press drive side, a cutout 77 for the passage of a shaft 78, such as, for example, a driveshaft 78 of a journal 63, 64 of a cylinder 06, 07. The lateral frame 11, 12, on the drive side of the printing press, also preferably has a relief or an opening for the driveshaft 78. It is not absolutely necessary to provide a cutout 77 or a relief in the lateral frame 11, 12 on the front side of the printing press, which front side is opposite the drive side of the printing press.

Viewed in the actuating direction S, as seen in FIG. 4, a length of the linear bearing 70, including the fixed bearing unit 72 and the movable bearing unit 73, and in particular, at least a length of the fixed bearing unit 72, which is fixed in place on the frame in the mounted state, of the linear bearing 70, is preferably less than a diameter of the associated cylinder 06, 07.

The connection of the cylinder 06, 07, or of the bearing block 74 on the drive side of the printing tower 01, to a drive mechanism, such as, for example, to a drive motor 121, takes place, as shown, by way of example in FIG. 3, via the drive shaft 78 which, on its end close to the cylinder, encloses an end of the cylinder journal 63, 64 and which is connected with the cylinder journal 63, 64 in a torsion-proof manner, such as, for example, by the use of a clamping arrangement 66. The clamping arrangement 66 is embodied as a partially slit hollow shaft end, which encloses the journal end of journal 63, 64 and which can be drawn tight into positive connection with the journal end 63, 64 by the use of a screw connection. This can be accomplished in such a way that a frictional connection, which is fixed against relative rotation, between the journal end of journal 63, 64 and the interior surface of the hollow shaft, of the clamping arrangement, can be made. A connection can also be made in another way, such as, for example, by making a positive connection in the circumferential direction. The shaft 78 is led through a cutout in the lateral frame 11, 12, whose size is sufficiently large for allowance of the movement of the shaft 78, together with the bearing block 74, and which cutout is formed, for example, in the manner of an elongated hole. As a protection against the ingress of dirt, it is possible to provide a cover 69, with a collar which is covering the elongated hole, which cover 69 is connected with the bearing block, for example, but not with the shaft 78.

As represented in FIG. 3, a coupling 148 of possibly several disks, which are arranged in series, and in particular a multiple-disk coupling 148, can be coupled to the end of the drive shaft 78, which is remote from the cylinder, by the use of a connection 75 which is fixed against relative rotation, and which is provided, such as, for example, a clamping element 75. In a different embodiment of the present invention, which is not specifically represented, a gear with a drive motor 121, and without a coupling 148 for use in compensating for angles and/or offsets, can be directly connected to the shaft 78. In this non-depicted embodiment, the drive motor 121 is arranged not fixed to the frame, but instead is fixed to the cylinder, and is movable together with the cylinder 06, 07.

On a side of the printing press, which is opposite the drive side of the cylinder 06, 07, in particular opposite to the drive side of the cylinder 06, which is embodied as a forme cylinder 06, the journal 64 is preferably connected with an arrangement for accomplishing the axial movement of the cylinder 06, such as, for example, with a lateral register drive mechanism, which is not specifically represented. For this purpose, the shaft 78, which may be connected with the journal 63, 64 in the way shown in FIG. 3, is connected by the use of a bearing, such as, for example, by an axial bearing, with an axial drive mechanism.

The embodiment of the linear bearings 70 in such a way that the bearing elements 72, 73, which work together, are both provided at the component bearing unit 14, and not as one part at the lateral frame 11, 12 of the printing tower 01, or of the printing unit 03, makes possible a pre-assembly and a pre-adjustment or setting of the bearing tension. The advantageous arrangement of the two linear bearings 70 enclosing the bearing block 74 makes possible a setting free of play. This is because the two linear bearings 70 are placed opposite each other in such a way that the initial bearing tension and the bearing forces undergo, or absorb, a substantial component in a direction which is perpendicular to the axis of rotation of the cylinder 06, 07. Therefore, the linear bearings 70 can be adjusted in that direction, perpendicular to the axis of cylinder rotation, which adjustment is important for the setting, free of play, of the cylinders 06, 07.

Since the cylinder 06, 07, including the journals 63, 64 and the bearing unit 14, do not themselves penetrate the lateral frame 11, 12, they, already pre-assembled, as well as the pre-adjusted or correctly initially tensioned bearings, including the radial bearing 71, as well as the linear bearing 70 can be inserted, in the form of a module, as cylinder unit 80 into the printing unit 01. With respect to “non-penetration”, and to the above definition, in regard to the clearance, it should be advantageously understood in the wider sense that there is such a “non-penetration”, at least in the area of the intended final position of the cylinders 06, 07, and at least on a continuous path from a frame edge to the location of the final position. The cylinder unit 80, as depicted in FIG. 3, can thus be brought into a final position from a direction of an open side located between the two lateral frames 11, 12 at the front without tilting, in a position with the cylinder axis of rotation perpendicular to the plane of the frame, and can be arranged there between the two inner frame walls, and in particular can be fixed in place on the two inner frame walls. This is, for example, also possible, even though gate elements or other raised portions are provided on the inside of the frame, the mentioned continuous mounting path is provided, however.

The bearing units 14 are arranged on the inner walls of the lateral frames 11, 12 in such a way that the cylinders 06, 07, and in particular their bearing units 14, are supported, on the side of the bearing units remote from the cylinders, by the lateral frame 11, 12, an arrangement which has static and assembly advantages.

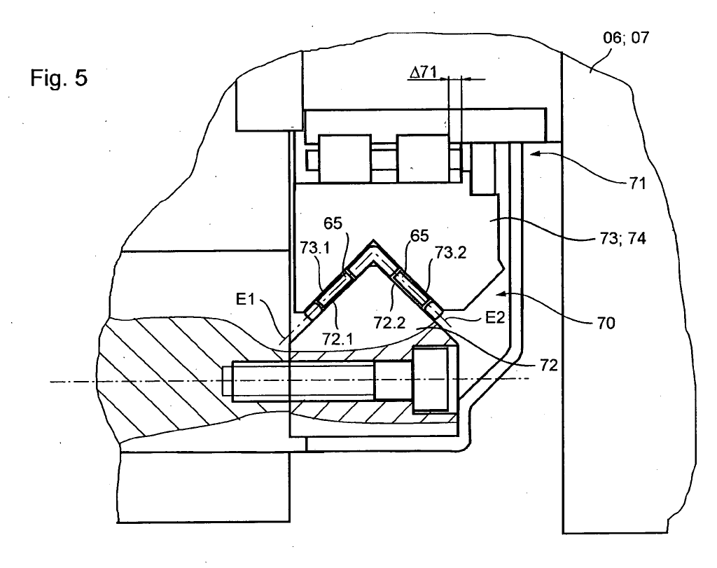

The linear bearings 70, including the bearing units 72, 73 represented in FIGS. 3 and 4, therefore each have pairs of corresponding cooperating bearing elements 72 and 73, or their guide or effective surfaces, embodied as sliding surfaces, which is not specifically represented, or with rolling bodies 65 between them, as seen in FIG. 5. As is represented in FIG. 5, in a preferred embodiment of the present invention, at least one of the two, and advantageously both of the, linear bearings 70 of a bearing unit 14 I, or are embodied in such a way that the two corresponding bearing units or elements 72 and 73 each have at least two guide surfaces 72.1, 72.2, 73.1, 73.2, which guide surfaces are located in two planes E1, E2, which are inclined toward each other. The two guide surfaces 72.1, 72.2, 73.1, 73.2, or their planes E1, E2 of the same bearing unit or units 72, 73 are inclined with respect to each other, such as, for example, in a v-shape, and for example at an interposed angle of between 30° and 60°, and in particular of between 40° and 50°. To this end, the two guide surfaces 73.1, 73.2, 72.1, 72.2 of the cooperating bearing unit or elements 72, 73 are inclined in complementary shapes. At least one of the two pairings of cooperating guide surfaces 72.1, 73.1, or 72.2, 73.2 lies parallel to a plane E1 or E2, which has a component, that is not equal to zero, in the radial direction of the cylinder axis. This prevents the free degree of movement in a purely axial direction of the cylinder 06, 07. Preferably, both pairings are located, with respect to levels E1, E2, both of which have a component not equal to zero in the radial direction of the cylinder axis, but with an opposite inclination to the cylinder axis, and therefore prevent the free degree of movement in both axial directions of the cylinder 06, 07. An intersection line of the two planes E1, E2 extends parallel with the actuating direction S, as may be seen in FIG. 4.

If, as can be seen in FIG. 3, the bearing block 74 is enclosed between both linear bearings 70, each having two pairings of cooperating guide surfaces 72.1, 73.1 and 72.2, 73.2, and in particular if the bearing block 74 is prestressed with a pre-tension, the bearing block 74 has only one free degree of movement along the actuating direction S.

The inclined effective or guide surfaces 72.1, 73.1, 72.2, 73.2 are arranged in such a way that they counteract a relative movement of the bearing elements of the linear bearing 70 in the axial direction of the cylinder 06, 07. In other words, the linear bearing 70 is “set” in the axial direction.

Advantageously, the linear bearings 70 of both of the bearing units 14, which are assigned to the front of a cylinder 06, 07, have two pairs of cooperating effective surfaces or guide surfaces 72.1, 73.1, 72.2, 73.2 which are arranged in this way with regard to each other. However, in this case, at least one of the two radial bearings 71 of the two bearing units 14 advantageously has a slight bearing play, Δ71, in the axial direction of the cylinders 06, 07.

In FIGS. 3 and 4, the guide surfaces 72.1, 72.2 of the bearing unit 72, which is fixed on the frame, and which is one component of the linear guide 70, point into the half-space facing the journal 63, 64. The bearing unit 72, which is fixed on the frame, here extend around the bearing block 74 which is arranged between them. Thus, the guide surfaces 72.1, 72.2 of the bearing unit 72, which is fixed on the frame, of the two linear guides 70 partially extend around the guide surfaces 73.1, 73.2 of the bearing block 74 with respect to an axial direction of the cylinder 06, 07.

Mounting aids 89, such as, for example, set pins 89, can be provided in the lateral frame 11, 12 and can be used to aid in the correct placement of the bearing units 14, or of the cylinder units 80, including the bearing unit 14, on which mounting aids 89 the bearing unit 14 of the completely assembled cylinder unit 80 is aligned prior to being connected with the lateral frame 11, 12 by releasable retaining elements means 91, such as, for example, screws 91, or even by material-to-material contact by welding. Appropriate elements 92, such as, for example clamping screws 92, can be provided, as may be seen in FIG. 3, for setting the bearing pre-tension in the linear bearings 70. This setting may be performed prior to insertion of the bearing assembly and cylinder into the printing unit 03 and/or for re-adjustment following insertion. The bearing unit 14 is embodied as a component, which is protected against dirt, at least in the direction toward the cylinder side, to a large degree by a cover 94, or may even be encapsulated.

The cylinder 06, 07 with journals 63, 64 and with a preassembled bearing unit 14 is schematically represented in FIG. 3. This module can be inserted, in an assembly-friendly manner, between the lateral frames 11, 12 of the printing unit 03, or of the printing tower 01, and can be fastened at locations intended for this. For a modular construction, the bearing units 14 for the forme cylinder 06 and for the screen roller 07 have advantageously been embodied structurally identical, possibly so far as up to the permissible operational size of the respective actuating path for the respective cylinder 06 or roller 07. Because of the embodiment of the present invention with pre-assembly, the effective inner surface of the radial bearing 71 and the effective outer shell surface of the journal 63, 64 can be embodied as being cylindrical instead of as being conical. This is because the mounting of the bearing unit 14 on the journal 63, 64, as well as the setting of the bearing play, can take place outside of the printing unit 03. For example, the bearing unit 14 can be shrunk on.

The structural unit, or bearing unit 14 which can be mounted as a whole, is advantageously located in the manner of a housing, possibly open in part, of, for example, the support 78 and/or for example, is provided as a frame, without a reference symbol in FIG. 4, for example with the four panels delimiting the bearing unit 14 toward the exterior on all four sides and/or, for example, with the cover 94, as seen in FIG. 3. The bearing block 74 having the radial bearing 71, the linear guides 70, as well as, in an advantageous embodiment, the actuator 82, or the actuators 82, for example, are housed inside of this housing, or this frame.

The bearing elements 72, which are fixed to the frame, are arranged substantially parallel to each other and define the actuating direction S, as is depicted in FIG. 4.

Placement of the cylinder 06 and/or of the roller 07 into the print-on position takes place by movement of the bearing block 74 in the direction of the print location by the application of a force F that is exerted by at least one actuator 82 on the bearing block 74. In particular the force F can be applied by the use of a force-controlled actuator 82 or of one defined by a force, by the use of which, a defined, or a definable, force F can be applied, in the print-on direction, on the bearing block 74, as depicted in FIG. 4. The line force in the nip locations which line force is, inter alia, decisive for ink transfer, and therefore of print quality, is not defined by an actuating path. Instead, it is defined by the force equilibrium between the force F and the line force F_{L} resulting between the cylinders 06, 07, and the resultant equilibrium. In a non-represented embodiment, cylinders 06, 07 are placed against each other in pairs because the bearing block 74 is charged with the appropriately set force F through the actuator or actuators 82.

At a side of the bearing unit 14, which is facing the print location, the bearing unit 14 has an element 79, such as, for example, a detent 79, whose location can be changed and which acts to delimit the actuating path toward the print position. The position of the detent 79 can be changed in such a way that a detent face 83, which acts as the detent, can be varied along the actuating direction S at least in an area. Thus, in an advantageous embodiment of the present invention, an adjusting device or adjustable detent 79 is provided, by the use of which the location of an end position of the bearing block 74 close to the print position can be set. A key-type drive mechanism, which will be described below, is used for the path limitation/adjustment. In principle, setting of the detent 79 can take place manually or by the use of an adjusting assembly 84, which is embodied as an actuator 84, as discussed below) Moreover, in an advantageous embodiment, a holding or clamping assembly, which is not specifically represented in FIGS. 3 and 4, is provided, by the use of which, the detent 79 can be fixed in place in the desired position. Furthermore, at least one resiliently acting element 81, such as, for example, a spring element 81, is provided, which spring element 81 exerts a force F_{R} on the bearing block 74, located away from the detent 79 and in a direction which is away from the detent face 83. This means that the spring element 81 cause a print-off placement of the respective cylinder in case the bearing block 74 is not prevented from moving in another way. Print-on placement occurs by moving the bearing block 74 in the direction of the detent 79 by operation of at least one actuator 82, and in particular by the use of a force-controlled actuator 82, by the use of which a defined, or a definable force F, in the print-on direction, can be selectively applied to the bearing block 74 for contact. If this force F is greater than the restoring force F_{R} of the spring elements 81, and given a corresponding spatial embodiment, a placement of the cylinder 06, 07 against the adjoining cylinder 06, 07 and/or a placement of the bearing block 74 against the detent 79 takes place.

In an ideal case, the exerted force F, the restoring force F_{R}, and the position of the detent 79 are selected in such a way that, in the contact position, no substantial force ΔF is transmitted between the detent 79 and the detent face of the bearing block 74, so that for example the following applies: |ΔF|<0.1*(F−F_{R}), in particular |ΔF|<0.05*(F−F_{R}), ideally |ΔF≈0. In this case, the contact force between the cylinders 06, 07 is essentially determined by the force F which is exerted by the actuator 82. The line force in the nip locations which is, inter alia, decisive for ink transfer, and therefore for print quality, is therefore not defined primarily by an actuating path but, with a quasi-free detent 79, is defined by the force F and the resulting equilibrium. In principle, after finding the base setting, with the forces F suitable therefor, a removal of the detent 79, or of a corresponding fixation in place, which is only active during base setting, would be conceivable.

In principle, the actuator 82 can be embodied as any arbitrary actuator 82 which is capable of exerting a defined force F. The actuator 82 is advantageously configured as an actuating assembly 82 which can be operated by a pressure source, and in particular which is configured as a piston 82 that is movable by the use of a fluid. In view of possible twisting, the arrangement of several, and as depicted in FIG. 4 two, such actuators 82 is advantageous. Because of its incompressibility, a liquid, such as, for example, oil or water, is preferably used as the fluid.

For placement of the cylinders 06, 07 into the print-on position, the bearing unit 14, which can be mounted in one piece, has two actuators 82, which can be simultaneously actuated, which act in the same direction and whose force attack points on the bearing block 74 are spaced apart from each other in a direction which is perpendicular to the cylinder axis.

A controllable valve 93 is provided for use in operating the actuators 82, which are here configured as hydraulic pistons 82, in the bearing unit 14. For example, valve 93 is configured to be electronically triggerable and, in one position, relieves the pressure from a hydraulic piston, or at least places that pressure on a lower pressure level, while in the other position of the valve 93, the pressure P, which causes the force F, is applied. In addition, a leak line, not specifically depicted here, is provided for safety.

To avoid too large contact/out-of-contact paths, but to still prevent tangled webs, it is possible to provide a path limitation on the side of the bearing block 74, remote from the print location, by the provision of a detent 88, whose location can be changed and whose force can be limited. Detent 88 can act as an overload safety device, and can be configured, for example, as a spring element 88 which detent 88, in the operational print-off position, in which print-off position the pistons 82 do not exert pressure and/or have been retracted, is used as a detent 88 for the bearing block 74 in the print-off position. In case of an entangled web or other excess forces exerted from the direction of the print position, detent 88 does yield and releases a larger path of travel of the bearing block 74. Therefore, a spring force of this overload safety device or detent 88 has been selected to be greater than the sum of the spring forces from the spring elements 81. Therefore, a very short actuating path, of, for example, only 1 to 3 mm, can be provided for making operational contact/out-of-contact.

In the represented embodiment, as shown in FIG. 4, the detent 79 is embodied as a key 79, which can be moved transversely in respect to the actuating direction S. The position of the respectively effective detent face 83 varies over the actuating direction S when detent or key 79 is moved. The key 79 is, for example, supported on a detent or frame element 96 which is fixed in place on a support.

The detent 79, here configured as a key 79, can be moved by the use of an actuator 84, such as, for example, by the use of an actuating assembly 84, which can be actuated by a pressure-medium, such as a piston 84 which can be actuated by means of a pressure-medium in a work cylinder with a double-acting piston, via a transmission member 85, configured as a piston rod 85, or by an electric motor via a transmission member 85 which could be embodied as a threaded spindle. This actuator 84 can either be active in both directions or, as represented in FIG. 4, can be embodied as a one-way actuator which, when activated, works against the force of a restoring spring 86. For the above mentioned reasons, including providing detent 79 free of force as much as possible, the force of the restoring spring 86 has been selected to be so weak that the key 79 is maintained in its correct position only to overcome the force of gravity or vibration forces.

In principle, the detent 79 can also be configured in another way, such as, for example, as a tappet, which can be adjusted and fixed in place with respect to the actuating direction S such that it forms a detent face 83, which can be varied in the actuating direction S and which can be fixed in place, at least during the adjusting process, for the movement of the bearing block 74 in the direction of the print location. In an embodiment of the present invention, which is not specifically represented, setting of the detent 79 takes place, for example, directly parallel with the actuating direction S by a drive element, such as, for example, by a cylinder which can be operated by a pressure medium and which has a double-acting piston, or by an electric motor.

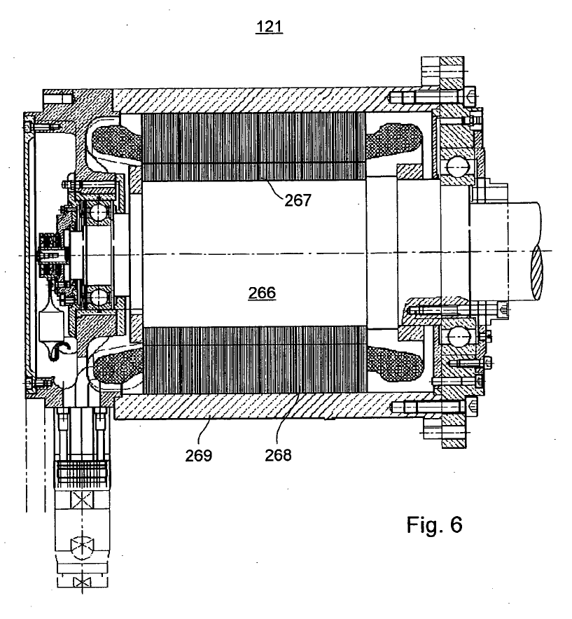

In the discussion which follows, and by making reference to FIG. 6 to FIG. 10, a drive motor 121, which can be, in particular, respectively either an electric motor 121, whose angular position is regulated, and preferably a synchronous motor 121 or a drive motor 121 with excitation by a permanent magnet will be discussed. Such drive motors 121 are, in particular, used for driving a rotating body 05, 06, 07, and in particular are used for driving a cylinder 05, 06, 07, or in other words the satellite cylinder 05, the forme cylinder 06 and the screen rollers 07 of the flexographic printing press.

FIG. 6 shows an embodiment of a drive mechanism by the use of such a drive motor 121, which is embodied as a synchronous motor 121 and/or as drive motor 121 with excitation by a permanent magnet and having a rotor or armature 266. The synchronous motor 121 may, for example, be configured as a synchronous motor 21 whose field can be weakened. Weakening of the field of the synchronous motor 121 is, for example, provided up to a ratio of 1:10. Motor 121, as shown in FIG. 6, has six poles, for example, and is electrically excited.

The motor 121, which may be embodied either as a synchronous motor 121 or as an excited permanent motor 121, preferably has permanent magnet excitation. In other words it is configured to be excited by a permanent magnet. The rotor 266, or armature 266, of the synchronous motor 121 has poles which are constituted by permanent magnets 267. For example, motor 121 has a constant zero-speed moment in the range between 100 Nm and 200 Nm. The synchronous motor 121 advantageously has a maximal torque in the range between 600 and 800 Nm and, in particular has a maximum torque of approximately 700 Nm. The permanent magnets 267 preferably contain rare earth materials.

The motor 121, which may be embodied as a synchronous motor 121 or as a permanently excited motor 121, has, for example, a theoretical idling speed in the range between 500 U/min and 600 U/min.

To accomplish rpm regulation, for example, a frequency converter may be connected upstream of the motor 121, which may be embodied as a synchronous motor 121 or as a permanently excited motor 121.

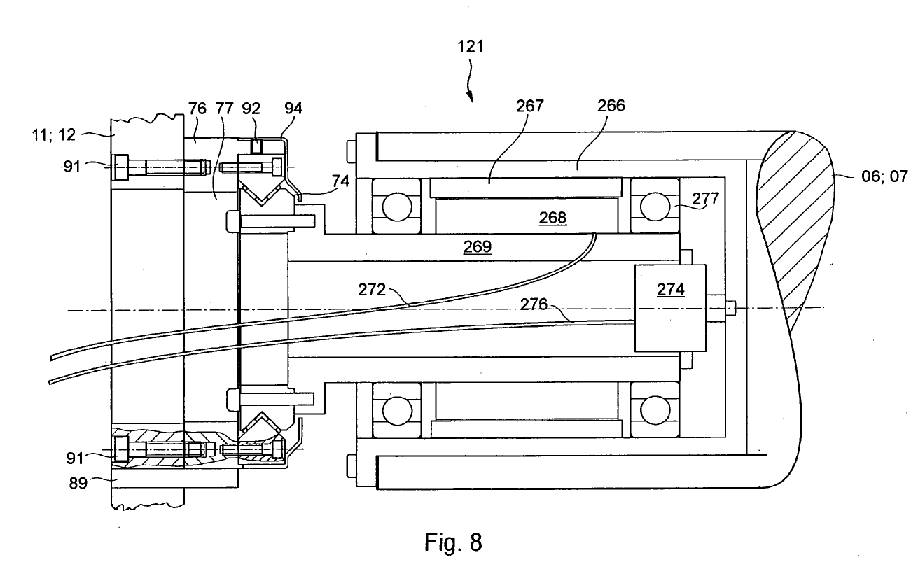

An angle of rotation sensor 274 is preferably provided on the motor 121, which motor 121 is embodied as a synchronous motor 121 or as a permanently excited motor 121. Note FIG. 8 for a depiction of this angle of rotation sensor.

A cooling arrangement, and in particular a ventilator wheel or a liquid coolant circuit, is advantageously provided on the motor 121, which motor 121 is embodied as a synchronous motor 121 and/or as a permanently excited motor 121.

In addition, a braking device can be provided on the motor 121, which motor 121 is embodied as a synchronous motor 121 or as a permanently excited motor 121. However, during generator operation the motor 121 can also be employed as a braking device.

An axis of rotation of an angle of rotation sensor 274 can be arranged coaxially to the axis of rotation of the rotor 266 of the motor 121.

The stator 269 of the electric motor 121 has windings 268 for use in generating magnetic fields by the application of electrical energy.

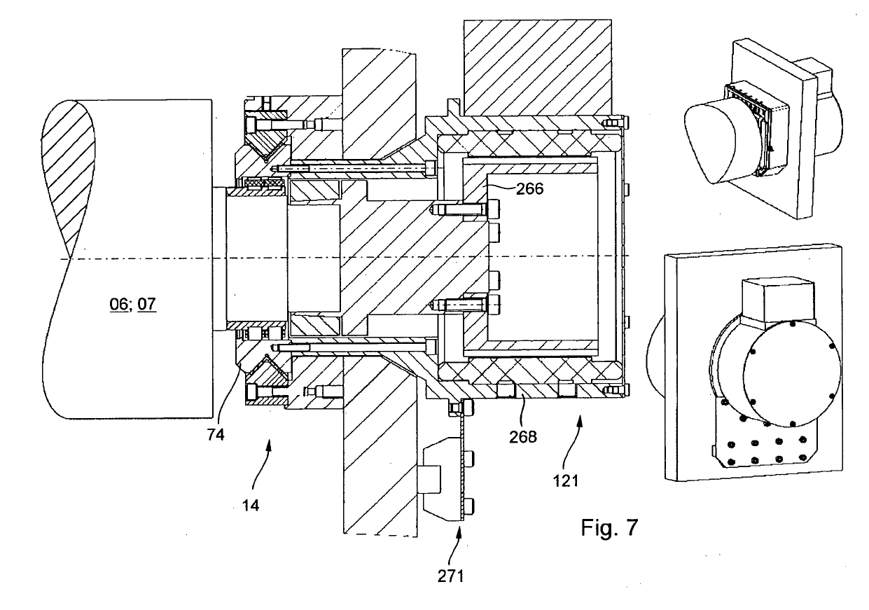

FIG. 7 shows an embodiment of a drive mechanism of a roller or of a cylinder 06, 07, and in particular shows the drive mechanism of a forme cylinder 06 or a screen roller 07 with bearing units 14, with the use of a drive motor 121, which is embodied either as a synchronous motor 121 or as a permanently excited motor 121, or in other words, as a motor 121 with a section of permanent magnets configured as a rotor 266. In this case, the stator 269 is, for example, directly fastened on the movable portion of the bearing unit 14, such as, for example, by being fastened on the movable bearing block 74, and is movable together with it. A guide device 271 can be provided for the synchronous motor 121, which motor 121 is here permanently excited, and on which guide device 271 the motor 121 slides.

In an advantageous variation of the present invention, the drive motor 121 is embodied for being rotatorily driven as an exterior rotor motor, particularly also one with permanent magnets 267 at the rotor 266, which is now located on the exterior, as seen in FIG. 8. The rotor 266 now is, for example, connected with the shell body of the cylinder 06, 07, or is constituted by that shell body. The windings 268 of the stator 269 are provided with electrical energy through electrical lines 272, for example. In principle, an angle of rotation sensor 274 can be connected, fixed against relative rotation, with the cylinder 06, 07 and/or the rotor 266 at arbitrarily different locations, such as, for example, also on the other front end of the cylinder 06, 07, and has for example a signal line 276 for drive control. In the example depicted in FIG. 8, it is connected with the rotor 266. The stator 269 and the rotor 266 are supported on each other by the use of bearings 277, which, in this case, are radial bearings 277. In this case, the radial bearings 277 in the bearing block 74 in FIG. 3 are left out. The stator 269 is connected, fixed against relative rotation, with the bearing block 74 and can be moved linearly together with it.

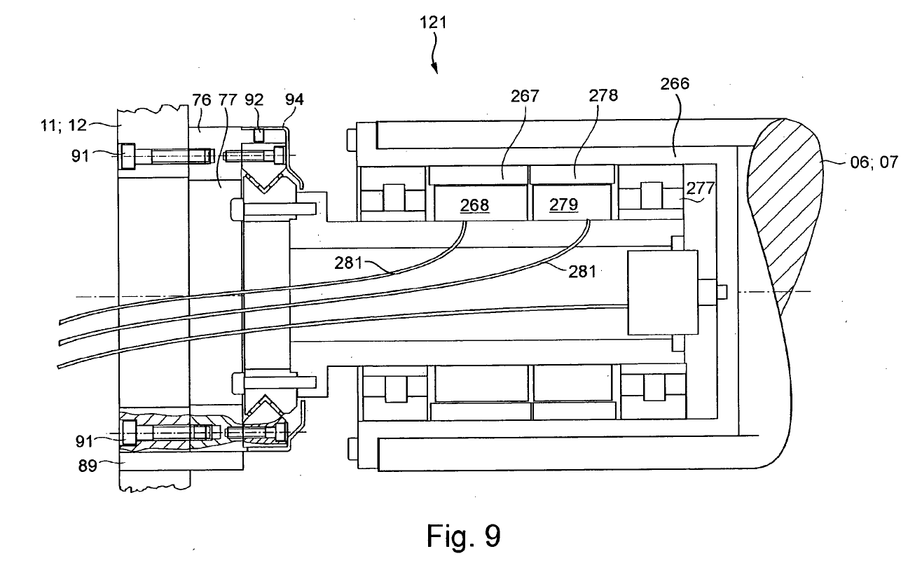

FIG. 9 shows an advantageous variation of the present invention wherein, in particular in case of a cylinder 06 that is embodied as a forme cylinder 06, an axial movement, by the use of the drive motor 121, should take place. For this purpose, the rotor 266 has a section which is covered, in a different way, with permanent magnets 278. Here, the poles of the permanent magnets 278 alternate, for example, in the axial direction. In contrast thereto, the poles in the section of permanent magnets 278, which are intended for rotatory driving, alternate, for example, in the circumferential direction, as may also be seen in FIG. 8. Windings 279, which are different from the windings 268, are arranged opposite the section of permanent magnets 278, which are intended for axial movement. Such windings 279 can be controlled for adjusting the lateral register by a printing press control device via their own signal lies 281. For example, the bearings 277 are configured as rolling bearings 277, which make an axial relative movement possible.

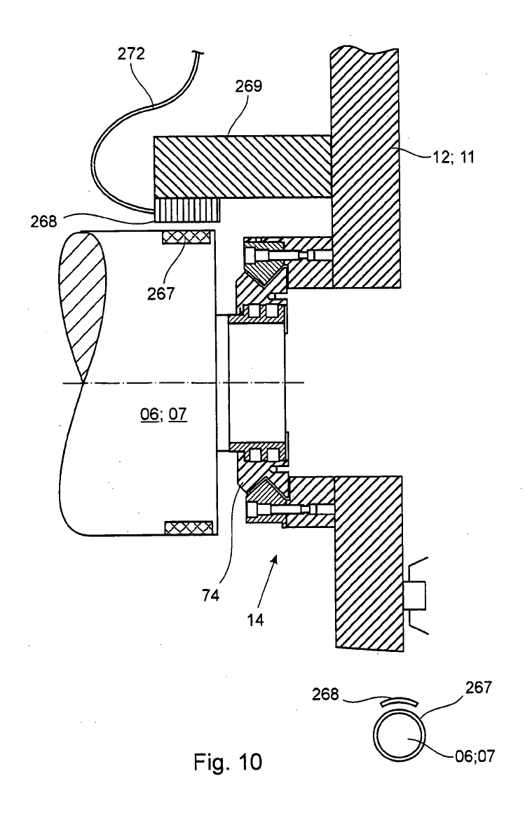

FIG. 10 shows another advantageous variation of a motor arrangement, wherein the cylinder 06, 07 has the permanent magnets 267 arranged in the circumferential direction in the area of its shell face or slightly underneath it. The stator 269 with the windings 268 is arranged, fixed to the frame outside of the cylinder or roller 06, 07, but inside of the two lateral frames 12, 11. The stator 269, which is supporting the windings 268, can extend around the entire circumference of the cylinder 06, 07, or can extend only over an angular segment, as depicted schematically at the bottom of FIG. 10. However, the permanent magnets 267 can also be arranged on a journal 63, 64 or on a tapering section at the end face of the cylinder 06, 07.

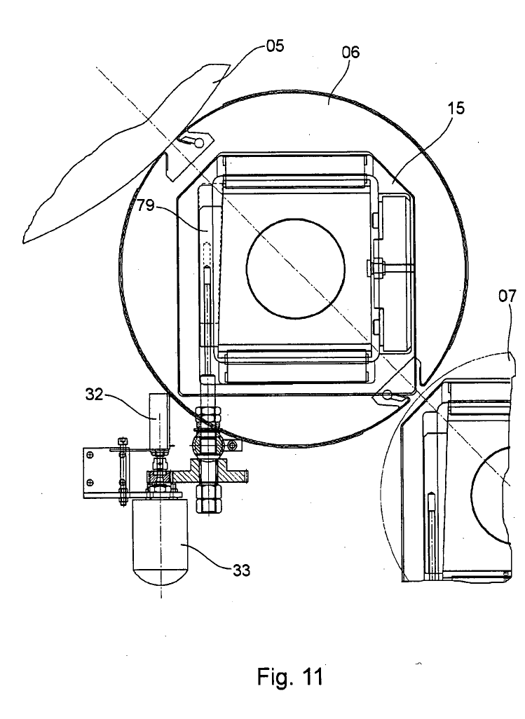

FIG. 11 shows a schematic side elevation view of a forme cylinder 06 in accordance with the present invention and with a linear bearing 15, such as has previously been described, in regard to its basic structure, in connection with FIGS. 3 to 5. The detent 79, which is embodied here as a detent key 79, is connected with an actuating motor 33 for driving the detent key. The position of the detent key 79 can be monitored, or can be controlled, by the use of a sensor 32, such as, for example, by the use of a potentiometer 32, which works together with the actuating motor 33.

Reference is now again made to FIG. 2. As embodied in FIG. 2, a linear bearing 15, which is of the type that has been explained in what has been said above, is assigned to each respective forme cylinder 06, to each screen roller 07 and to each chamber doctor blade 08. At least one drive motor 121, also of the type explained in what has been said above, is also assigned to at least the respective satellite cylinders 05, to the respective forme cylinders 06, as well as to the respective screen rollers 07.

Each forme cylinder 06 can be placed, finely adjustable, by the use of its linear bearing 15, against the assigned satellite cylinder 05. Each screen roller 07 can be placed, finely adjustable, by the use of its linear bearing 15, against the assigned forme cylinder 06. Each chamber doctor blade 08 can be placed, finely adjustable, by the use of its linear bearing 15, against the assigned screen roller 07, all of which cylinder and roller placements preferably being pressure-regulated.

The arrangement of the forme cylinders 06 at the circumference of the respective satellite cylinder 05, as seen in FIGS. 1 and 2, is such that the same distance exists between each contact line formed by the forme cylinder 06 with the satellite cylinder 05. In other words, the forme cylinders 06 are equidistantly distributed over the circumference of the satellite cylinder 05.

As in the case of the preferred embodiment depicted in accordance with FIG. 1, in the FIG. 2 embodiment the forme cylinders 06 are arranged, with respect to the respective satellite cylinder 05, in such a way that two forme cylinders 06 are located respectively diametrically opposite each other. In other words, the axes of rotation of the satellite cylinders 05 and of two forme cylinders 06 assigned to each of them are located on a common straight line.

The screen rollers 07 are arranged, with respect to the respective forme cylinders 06, in such a way that the axis of rotation of a screen roller 07, the axis of rotation of the assigned forme cylinder 06 and the axis of rotation of the assigned satellite cylinder 05 are all located on a common straight line. Based on the selected positions of the cylinders 05, 06 in relation to each other, there is achieved by this orientation that, when the forme cylinder 06 is placed against the satellite cylinder 05, the screen roller 07 can be synchronously displaced with the same displacement value as the forme cylinder 06. A pressure pre-tension which may be set between the screen roller 07 and the forme cylinder 06 thus does not change.

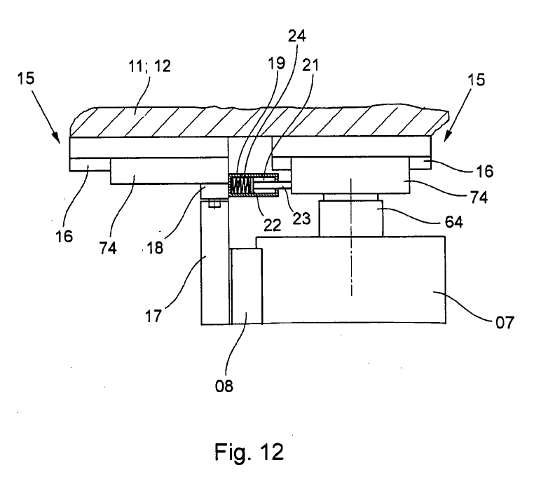

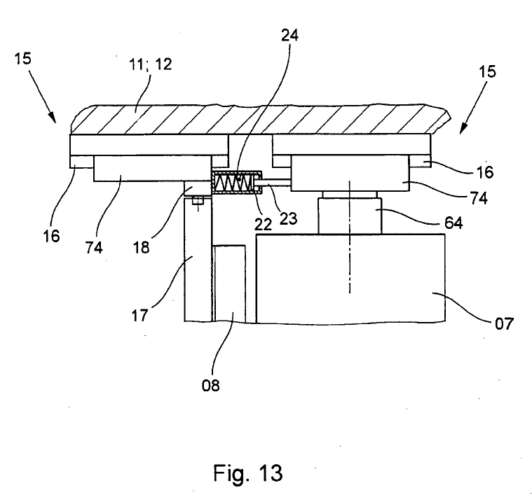

Furthermore, the chamber doctor blade 08, which is seated on the linear bearing 15, that is, in turn, coordinated to the linear bearings of the screen roller 07 and which is placed, in a pressure-regulated manner, against the assigned screen roller 07, is coupled with the linear bearing 15 of the screen roller 07 in such a way that the chamber doctor blade 08 is forced to follow every positional change of the screen roller 07 without a change in the print-on position. In principle, such a function can also be resolved by the use of control technology. However, the mechanical solution, as will be explained by reference now to FIGS. 12 and 13, has been selected:

FIG. 12 shows a top plan view of a mechanical connection of the linear bearing 15 of the chamber doctor blade 08 with the linear bearing 15 of the screen roller 07 in the state of operation in which the chamber doctor blade 08 has been placed against the screen roller 07. FIG. 13 shows the retracted state of the chamber doctor blade 08, with respect to the screen roller 07. The screen roller 07 is seated with its journal 64 in the linear bearing 15, specifically with its journal 64 in the carriage 74 of the linear bearing 15, which, in turn, is guided, linearly displaceable, on the linear guide 16 of the linear bearing 15 of the screen roller 07. The chamber doctor blade 08 is held by a cross arm 17 and a holder 18 in a linear bearing 15, specifically with the holder 18 in the carriage 74 of this linear bearing 15. The chamber doctor blade linear bearing 15 is, in turn, guided, linearly displaceable, on the linear guide 16 of the linear bearing 15 of the chamber doctor blade 08. The carriage 74 of the linear bearing 15 of the chamber doctor blade 08 is connected with the carriage 74 of the linear bearing 15 of the screen roller 07 in a manner in which their spacing can be varied, which connection can be constructively embodied in the following discussion.

An actuator 19 which, in particular, can be operated by a pressure medium and which actuator 19, in the case of the preferred embodiment, can comprise a force-controlled cylinder-piston arrangement 19, acts between the chamber doctor blade 08, or between the carriage 74 of the linear bearing 15 of the chamber doctor blade 08 and the carriage 74 of the linear bearing 15 of the screen roller 07. For this purpose, a cylinder 21, which can be supplied with a working fluid, is connected with the chamber doctor blade 08, or its carriage 74. A piston 22, which is displaceably guided in the cylinder 21, is connected, by its piston rod 23, with the carriage 74 of the linear bearing 15 of the screen roller 07. The chamber doctor blade 08 is pre-stressed into its disengaged position by the provision of a restoring spring 24 that is arranged in the cylinder 21, as may be seen in FIG. 13. By supplying working fluid to the cylinder 21, the chamber doctor blade 08 is brought into contact with the screen roller 07 with the desired pressure working against the pressure of the restoring spring 24, as may be seen in FIG. 12. As a result of the connection of the screen roller 07 and the chamber doctor blade 08, by the use of the actuator 19, the chamber doctor blade 08 is forced to follow each movement of the screen roller 07, without the engagement pressure between the chamber doctor blade 08 and the screen roller 07 changing. Thus, the pressure-controlled print-on position of the chamber doctor blade 08 is maintained because of the coupling that is formed between the chamber doctor blade 08 and the screen roller 07.

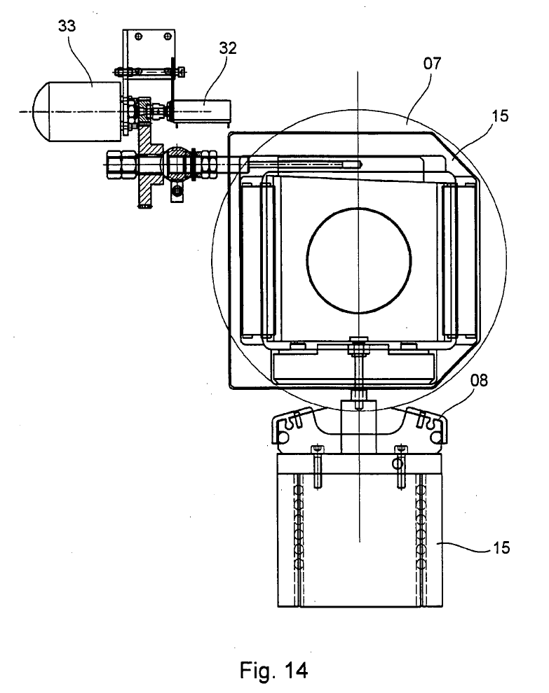

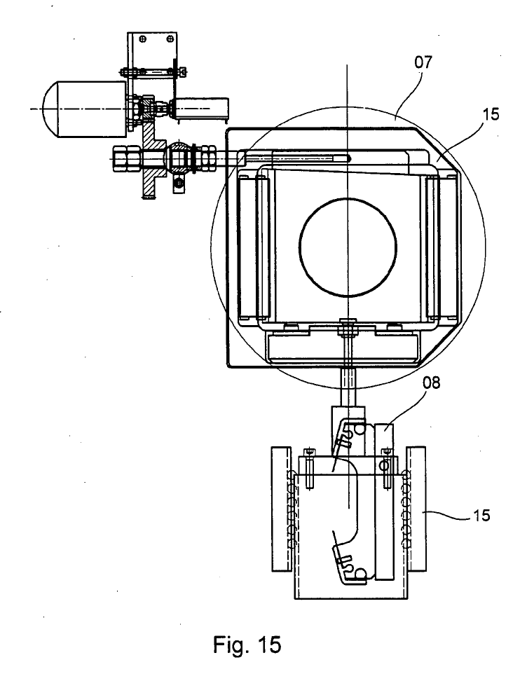

In a representation of a preferred embodiment of the present invention and corresponding to that depicted in FIG. 11, FIGS. 14 and 15 show the coupling between the screen roller 07 and the chamber doctor blade 08 in a top plan view taken perpendicularly to that taken in accordance with FIG. 12 or FIG. 13. In the representation in accordance with FIG. 15, the chamber doctor blade 08, which is now depicted as being disengaged from the screen roller 07, has been pivoted out of its functional position for the accomplishment of a blade change.

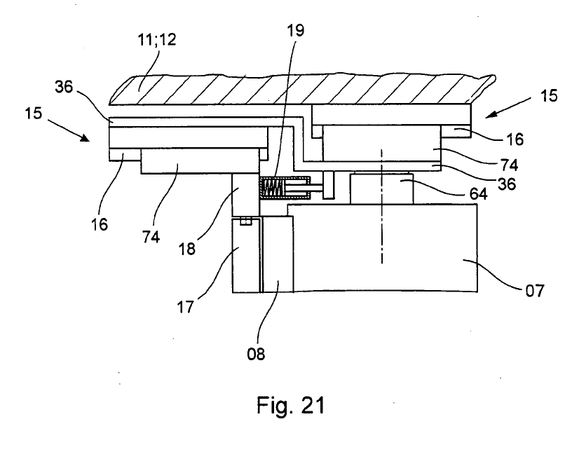

It should be pointed out that the principle of operation of the above-explained solution for the coupling between the screen roller 07 and the chamber doctor blade 08, as well as the principle which is represented in connection with FIG. 21, can also be advantageously applied in printing groups 04 other than those of flexographic printing groups 04, or in web-fed rotary printing presses other than flexographic printing presses, and is, in particular, not restricted to the coupling between a screen roller 07 and a chamber doctor blade 08. Instead, a coupling between other components 07, 08 is possible in the same way and advantageously, is possible, in particular, if both components 07, 08 are intended to be simultaneously, or synchronously, moved, or if, in particular, a pressure-regulated, print-on position between these components 07, 08 is intended to be maintained.

The basic adjustment, or the zero adjustment, of the linear bearings 15 will be explained in the discussion which now follows. To adjust a linear bearing 15, the forme cylinder 06 is preferably used without printing plates 27, or is covered with printing plates 27, such as, for example, flexographic printing plates 27 of a defined thickness. The detent key 79 of the linear bearing 70 is retracted, and the linear bearing 70 is placed, for example hydraulically, against suitable detents, such as the shell face of the counter-pressure cylinder or the satellite cylinder 05, or is placed against measuring rings or detents which are fixed in place on the frame. In this zero position, the detent key 79 is retracted and an acknowledgement of the position of the detent key 79 and/or of its assigned drive mechanism, such as an electric motor 121 is preferably provided to a control device. The detent key 79 is retracted, again by a predefined distance, from this zero position of the detent key 79, and therefore from the zero position of the forme cylinder 06 and/or of the screen roller 07, by the use of which retraction, the contact pressure, for bringing the cylinder 06 or the screen roller 07 into contact, is fixed.

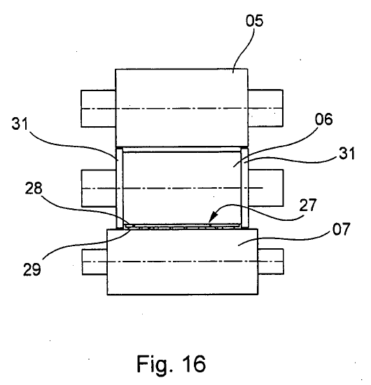

In particular, the zero adjustment of the linear bearings 15 can take place as will now be discussed in what follows. See also, in connection with this discussion, the depictions of FIGS. 16 to 18.

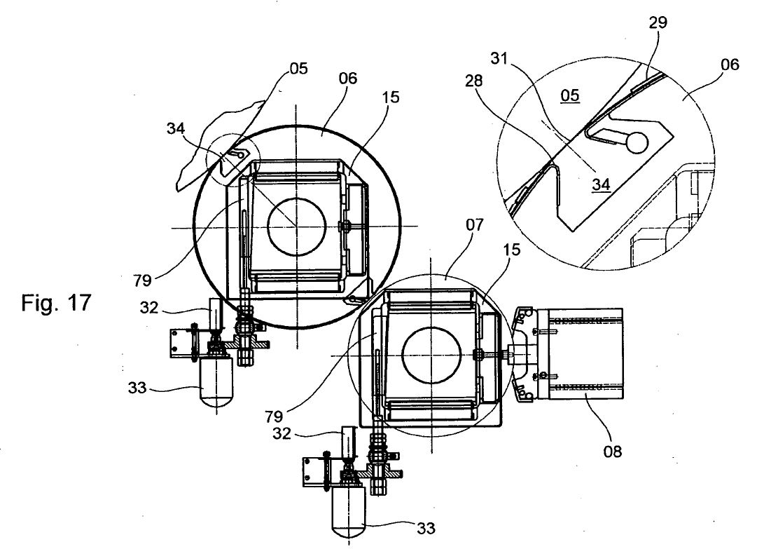

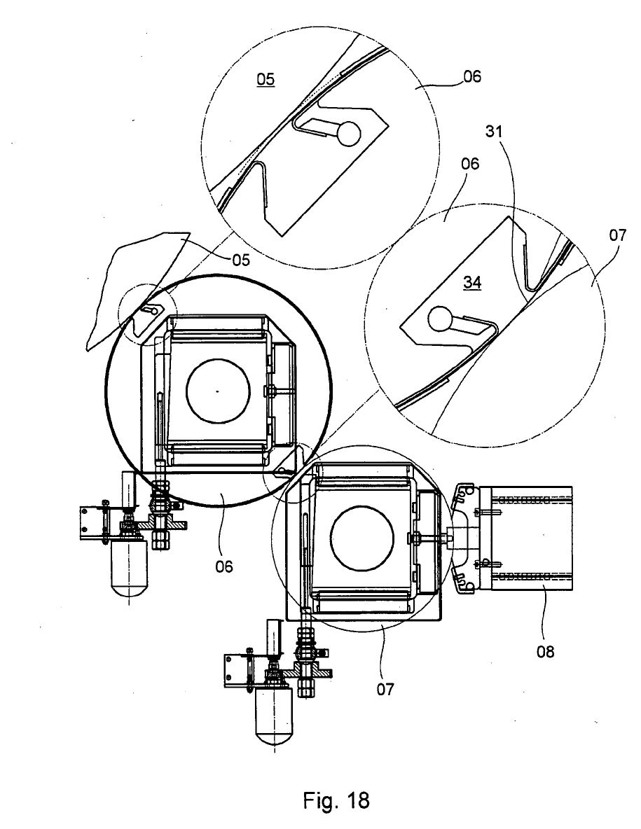

FIG. 16 shows a schematic top plan view of a cylinder group and consisting of a satellite cylinder 05, a forme cylinder 06 and a screen roller 07. On its circumference, the forme cylinder 06 has a printing plate 27 that is comprised of a support material 28 and the print image 29. Measuring rings 31 have been applied to the front or end faces of the forme cylinder 06. As becomes clear from a review of FIGS. 17 and 18, both the forme cylinder 06, as well as the screen roller 07, are each seated in a linear bearing 15 of the type which has previously been described above. The detent key 79 of the respective linear bearing 15 can be displaced by the use of an actuating motor 33, and the position of the detent key 79 can be monitored by the use of a potentiometer 32 which is assigned to the actuating motor 33.

For placement of the forme cylinder 06 against the satellite cylinder 05, the detent key 79 of the linear bearing 15 of the forme cylinder 06 is initially extended until the potentiometer 32 at the actuating motor 33 has reached the maximum value. Thereafter, the forme cylinder 06 is shifted in the direction of the satellite cylinder 05 by use of the hydraulic pistons 82, as is depicted in FIG. 4 until the measuring rings 33, which are arranged at the front faces of the forme cylinder 06 rest against the shell face of the satellite cylinder 05, as is depicted in FIGS. 16 and 17. The exterior diameters of the measuring rings 33 are selected in such a way that they project slightly past the support material 28 or the printing plate 27, but are still less than the actual diameter of the forme cylinder 06, which is constituted by the surface of the print image 29. The forme cylinder groove 34 should point to the center of the satellite cylinder 05. Because of this positioning, adjustment of the forme cylinder 06 is possible, with or without printing plates 27 having been installed.

This state of positioning is shown in FIG. 17. The measuring rings 31 of the forme cylinder 06 have been placed against the shell face of the satellite cylinder 05, and the forme cylinder groove 34 is oriented toward the center of the satellite cylinder 05. The structure of the measuring rings 31, with regard to the support material 28 and to the print image 29 of the printing plate 27 can be seen in the enlarged detailed view in FIG. 17.

In the next step, in accordance with the present invention, the hydraulic pistons 82, as may be seen in FIG. 4, are charged with maximum pressure pₘₐₓ, and thereafter the detent key 79 is moved into the gap by operation of the actuating motor 33, as seen in FIG. 17. The end position of the detent key 79 is indicated by the increased electric current consumption of the actuating motor 33, up to a maximum amount. The actuating motor 33 is switched off, and the pressure on the hydraulic pistons 82 is adjusted to a lower pressure p₁. In connection with this, it should be noted that the pressure pₘₐₓ must generate a greater contact force than the force Fₙ generated by the retracting detent key 79, which Force Fₙ is a function of the torque of the actuating motor 33. The pressure p₁ generates a lower contact force than the motor torque can generate at the detent key 79. However, it is also sufficiently large so that a dependable fixation of the forme cylinder 06 in place, during the printing process, is assured.

Subsequently, the detent key 79 is displaced, by operation of the actuating motor 33, over a predetermined length “x” into the gap, in order to pull the forme cylinder 06 away from the satellite cylinder 05 sufficiently far so that the gap size, which is required for printing, has been achieved. As a rule, in that case, the print image 29 then rests, under a slight prestress, against the paper which is to be printed. The position of the detent key 79 is always indicated by the utilization of the potentiometer 32 that is positioned at the actuating motor 33. Process-related changes in the gap can be realized by adjustment of the detent key 79, in the course of which changes the pressure-charged hydraulic pistons 82 always dependably clamp the carriage 74 of the linear bearing 70 against the detent key 79, as depicted in FIG. 4.

In the next step of the operation, in accordance with the present invention, and with the detent key 79 fully extended, the screen roller 07 is displaced toward the forme cylinder 06 until the measuring rings 31, which are arranged at the front or end faces of the forme cylinder 06, rest against the shell face of the screen roller 07. In this case, the forme cylinder groove 34 must point toward the screen roller center. In the next step, the hydraulic pistons 82 of the linear bearing 70 of the screen roller 07 are charged with a maximum pressure pₘₐₓ, and subsequently the detent key 79 is moved into the gap by operation of the actuating motor 33. The end position of the detent key 79 is indicated by the maximum electric current consumption of the actuating motor 33. The actuating motor 33 is switched off and the pressure being exerted on the hydraulic pistons 82 is adjusted to a lower pressure p₁. The detent key 79 is subsequently displaced into the gap by operation of the actuating motor 33 for a predetermined length “y” in order to move the forme cylinder 06 away from the screen roller 07 far enough that the gap size, which is required for printing, has been reached.

The upper detailed view depicted in FIG. 18 shows the forme cylinder 06, which has been adjusted, in relation to the satellite cylinder 05, following the setting of the gap size which is required for printing. The lower detailed view shown in FIG. 18 shows the placement of the screen roller 07 against the measuring rings 31 of the forme cylinder 06, while the forme cylinder groove 34 is aligned with respect to the axis of the screen roller 07.

Reference is now again made to FIG. 2. A first guide roller 26, with which the imprinted paper web 02 comes into contact with after printing, is arranged in such a way that the freshly imprinted side of the paper web does not come into contact with the surface of the guide roller 26. One, or several drying arrangements 25.1, 25.2, or dryers 25.1, 25.2 have been provided for use in drying the freshly imprinted paper web. At least one of these dryers 25.1, 25.2, in FIG. 2, and as depicted there at least the dryer 25.2, is arranged in such a way that the waste heat from the dryer 25.2 again dries the paper web 02 which is now running over it. In other words, the paper web 02 is guided in such a way that it extends slightly above a dryer 25.2 which dries a paper web 02 that is running underneath the dryer 25.2. In this way, the travel of the web 02, which is required for drying, or the time which is required for drying, is shortened, and the energy of the dryer 25.2 is particularly well utilized.

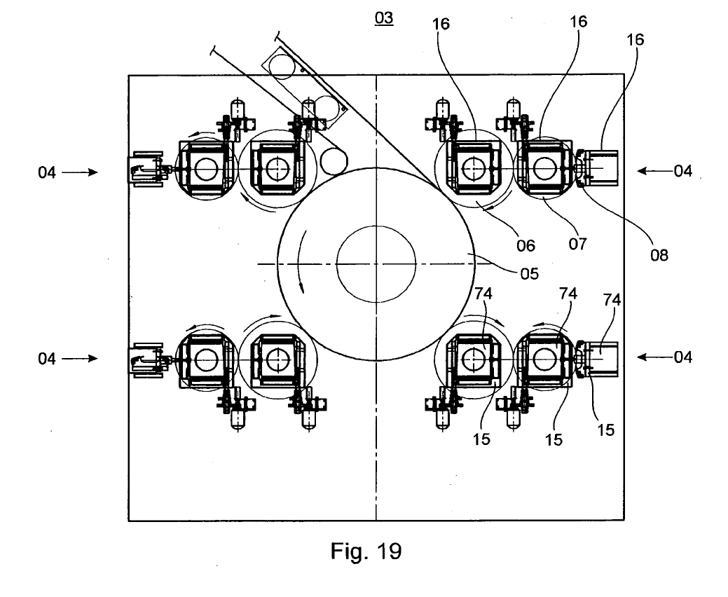

FIG. 19 shows a modification of the satellite printing unit which was represented in FIG. 2. In connection with the embodiment of the present invention, in accordance with the depiction FIG. 19, the linear guides 16 of the linear bearings 15 of the chamber doctor blade 08, of the screen roller 07 and of the forme cylinder 06 of each printing group 04 extend parallel, and in the case of the preferred embodiment, extend in particular, on a horizontal line, so that the groove beats or channel beats, which are formed between the forme cylinder 06 and the screen roller 07, cannot act on the linear guides 16. Moreover, with such an arrangement it is advantageous that all of the carriages 74 of all of the linear bearings 15 of a printing group 04 can be located in common linear guides 16.

In connection with the placement of the forme cylinder 06 against the satellite cylinder 05, it is also advantageous with such an arrangement, as depicted in FIG. 19, that, because of the selected position of the cylinders 05, 06, 07 with respect to each other, the screen roller 07 can now be displaced synchronously by the same placement amount as the forme cylinder 06, so that the pressure prestress between the screen roller 07 and the forme cylinder 06 does not change.

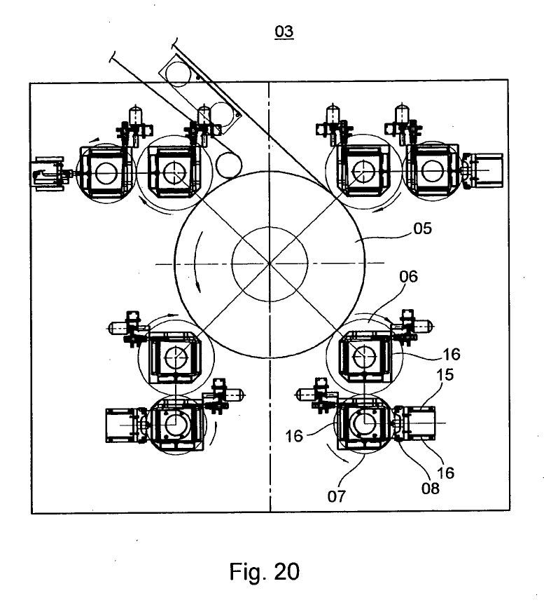

FIG. 20 shows a further modification of the satellite printing unit which is represented in FIG. 19. In this embodiment, the linear guides 16 of the two lower forme cylinders 06 and of the screen rollers 07 are arranged vertically for improving the serviceability of the printing group 03 in regard to plate attachment.

In connection with a placement of the forme cylinder 06 against the satellite cylinder 05, the screen roller 07 can now be displaced synchronously by the same placement amount as the forme cylinder 06 because of the selected position of the cylinders 05, 06, 07 in respect to each other. The result is that the pressure prestress, which exists between the screen roller 07 and the forme cylinder 06, does not change.

Differing from the preferred embodiment of the present invention, which is depicted in accordance with FIG. 19, the linear bearing 15 of the chamber doctor blade 08, or its linear guide 16, is, in another preferred embodiment, as shown in FIG. 21, not fastened in the lateral frame 11 or 12 of the printing unit 03. Instead, this bearing 15 or its guide 16 is positioned on a separate support element 36 which can be configured as an angled plate 36, and which is non-positively connected with the carriage 74 of the screen roller 07. In this configuration, the print-on position of the chamber doctor blade 08 against the screen roller 07 is independent of the movement of the screen roller 07.

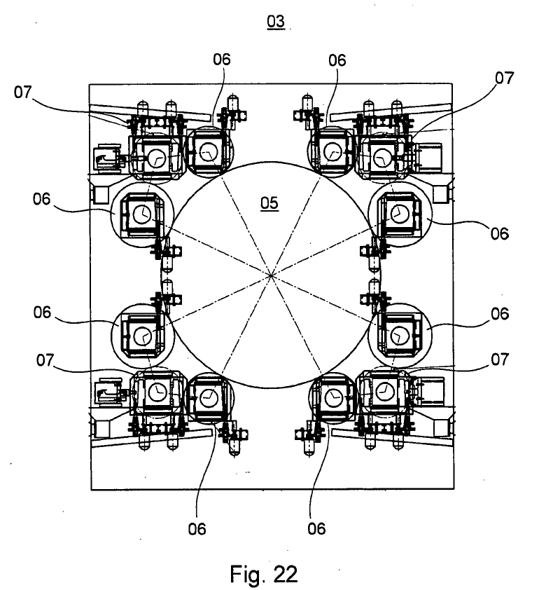

In accordance with a further embodiment of the present invention, a flexographic printing unit 03, such as, for example, a satellite printing unit 03 with at least eight forme cylinders 06, is provided, as seen in FIG. 22. In this embodiment, pairs of the forme cylinders 06 can have different diameters and/or only one common screen roller 07 may be respectively assigned to two forme cylinders 06. In the case of this embodiment in accordance with FIG. 22, a satellite printing unit 03 with eight forme cylinder 06 is represented. Only one common screen roller 07 is assigned to two forme cylinders 06 and both of the forme cylinders 06 of such a cylinder pair can have different diameters, or can have the same diameter for the purpose of imprinter operation. The single screen roller 07 can be selectively assigned to the larger forme cylinder 06 or to the smaller forme cylinder 06.

With a printing unit 03 of the configuration represented in FIG. 22, is possible, without the need for extensive modification work, to produce printed products of differing section length by the use of such a printing unit 03. The efficient utilization of the press is considerably increased by this configuration.

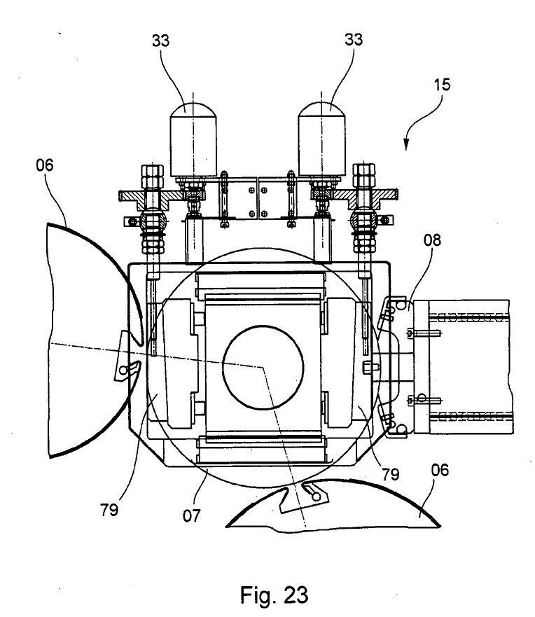

FIG. 23 shows, in a representation corresponding to FIG. 11, a linear bearing 15 of a cylinder 07, or of a screen roller 07, which has two detent keys 79. Such a linear bearing 15, in particular, can also be utilized in the case of the previously described preferred embodiment in accordance with FIG. 22, in which the screen roller 07 is movable between two forme cylinders 06.

Accordingly, the placement of the screen roller 07 takes place selectively, or alternatively, between the one and the other detent 79. A center position of the screen roller 07, in which it is in contact with neither of the two forme cylinders 06, is achieved, for example, in that the one detent key 79 is completely moved into the gap assigned to it, while simultaneously the oppositely located hydraulic piston 82 as depicted in FIG. 4, for example is or are charged with pressure.

In this case, the arrangement can in particular, be such that the hydraulic pistons 82 are mechanically connected, on both sides, with the carriage 74 of the linear bearing 70 of the screen roller 07. The rear of the hydraulic elements is configured as an inclined plane and, together with the associated detent key 79, forms an inclined plane.

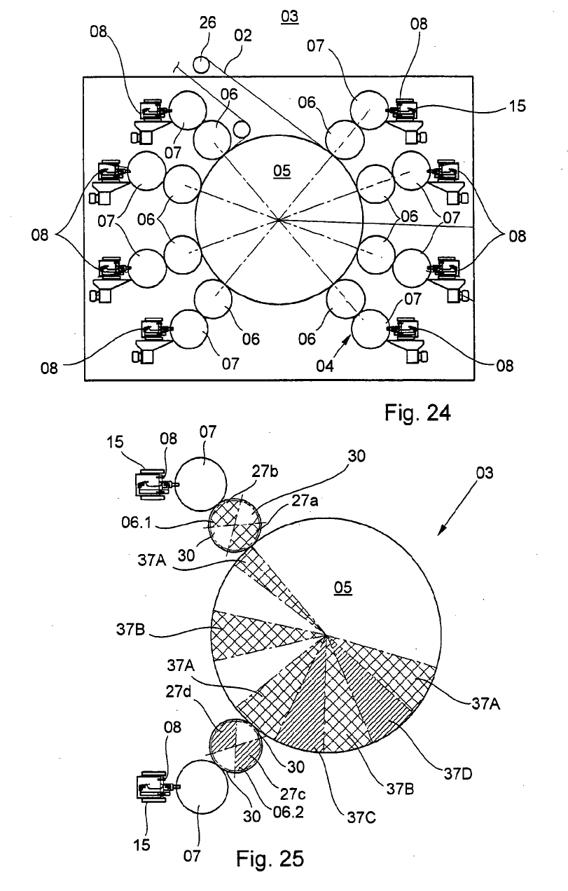

In addition to the embodiment explained above, by reference to FIG. 22, a further possibility for forming printed product, in accordance with the present invention, results from the case of the embodiment of the invention in accordance with FIGS. 24 and 25, which will be described in what follows.

As depicted in FIGS. 24 and 25, every printing unit 03 comprises a satellite cylinder 05 and at least eight forme cylinders 06, and in the case of the depicted embodiment of FIG. 24, exactly eight forme cylinders 06, or exactly eight flexographic printing groups 04. A screen roller 07 is assigned to each forme cylinder 06, and a chamber doctor blade 08 is assigned to each screen roller 07. Each forme cylinder 06 and each screen roller 07 has its own drive motor 121, which is not specifically represented here.

Moreover, every forme cylinder 06 is seated in a linear bearing 15, again, not specifically represented here and can be precisely placed against the satellite cylinder 05. Each screen roller 07 is also seated in a linear bearing 15, also not specifically represented here, and can be precisely placed against the forme cylinder 06. Furthermore, each chamber doctor blade 08 is seated in a linear bearing 15 and can be placed, in a pressure-regulated manner, against its associated screen roller 07. Each chamber doctor blade 08 is mechanically coupled with the linear bearing 15 of the associated screen roller 07 in such a way that it is forced to follow every position change of the screen roller 05 without a change in the print-on position. Reference is made, with regard to the respective details, to the previous description in connection with other preferred embodiments.

The screen roller 07 of each printing group 04 is arranged in such a way that the axes of rotation of the screen roller 07, the forme cylinder 06 and the satellite cylinder 05 are located on a common straight line. Based on the selected position of the cylinders 05, 06, 07 in relation to each other, it is possible, in the course of an advancement of the forme cylinder 06 toward the satellite cylinder 05, to displace the screen roller 07 synchronously with the same advancement amount as is imparted to the forme cylinder 06. The result is that the pressure pre-tension between the screen roller 07 and the forme cylinder 06 does not change.

Each forme cylinder 06 has, distributed in its circumferential direction, at least one printing section 27a, 27b, or 27c, 27d, and at least one non-printing section 30, all as is depicted schematically in FIG. 25. In particular, each forme cylinder 06 has, distributed in the circumferential direction, two printing plates 27a, 27b, or 27c, 27d, which define printing sections 27a, 27b, or 27c, 27d, and between which printing plates 27a, 27b or 27c, 27d the non-printing sections 30 are located, again, as may be seen in FIG. 25.

Viewed in the circumferential direction of the forme cylinders 06, the printing sections 27a, 27b, or 27c, 27d, or the printing plates 27a, 27b, or 27c, 27d, preferably are each of the same length and are distributed, preferably equidistantly, over the circumference of the forme cylinder 06.

It is possible to produce printed products with variable printing cylinder circumference lengths by the use of a printing unit 03 with the above-described configuration. This is achieved in that the print image 29 to be imprinted is distributed in equal parts on two printing plates 27a, 27b, or 27c, 27d, which are assigned to different forme cylinders 06.1, or 06.2, wherein the greatest length of the print image 29 may maximally amount to the circumference of a forme cylinder 06, less twice the width of the white edges, less an area for slowing or accelerating the forme cylinder 06.

The printing plate 27a of the first forme cylinder 06.1 deposits the first partial print image 37A on the paper web 02 which is being conducted over the satellite cylinder 05. The printing plate 27c of the second forme cylinder 06.2 subsequently deposits the second partial print image 37C on the paper web 02, maintaining the correct registration and color congruence. In the same way, the printing plate 27b of the first forme cylinder 06.1 deposits the first partial print image 37B on the paper web 02, and thereafter the printing plate 27d deposits the partial image 37D on the paper web 02. The imprinted partial images 37A and 37C, as well as the imprinted partial images 37B and 37D each constitute a section length.

To compensate for the difference between the cylinder circumference of the forme cylinder 06 and the print length, the forme cylinder 06 is slowed, by the use of drive techniques, and is thereafter again accelerated to the production rpm, which is accomplished, in particular, with the aid of the drive motors 121, or the synchronous motors 121, as explained with reference to FIGS. 6 to 10. By this process, the forme cylinder 06 is returned into the correct angular position, with regard to the printed product, in order to thereafter print at production speed, or paper speed.

It is advantageous in this context, in connection with letterpress printing, that the printing sections 27a, 27b, 27c, 27d are raised, and that the non-printing section 30 are located lower than the printing sections. The slow-down and acceleration process of the forme cylinders 06 takes place in the area in which the non-printing sections 30 rotate past the satellite cylinder 05 and the screen roller 07. In connection with the configuration, in which the screen roller 07, the forme cylinder 06 and the satellite cylinder 05 are located on a straight line, it is advantageous if, in its acceleration phase, the forme cylinder 06 is not in contact with either the paper web 02 or the screen roller 07, and in the course of the printing process, the one printing plate 27 is inked via the screen roller 07, while the other printing plate 27 is positioned to be printing. It also follows from this, that the circumferential speed of the screen roller 07 and of the satellite cylinder 05 are equal and are “constant”, and that only the forme cylinder 06 must be cyclically accelerated and slowed.

The production of three and more printed products of lesser section length can be realized in the same way. The printing plate 27a or the printing plate 27b now contains a whole partial image, as well as half of the second partial image. The printing plate 27c or the printing plate 27d now contains the second half of the second partial image, as well as an entire third of the whole third partial image.

By the use of a printing unit 03 which is configured as explained above, it is also possible to produce printed products having variable section length, provided that the longest product is shorter than half the cylinder circumference, less the white edge, as well as an area which is of such dimensions that the forme cylinder 06 can again be accelerated into its correct angular position in relation to the printed product.

As explained above, the embodiments of the present invention, in accordance with FIG. 22 on the one hand, and with FIGS. 24 and 25 on the other hand, make possible the production of printed products of variable section length, by the use of which, the variableness, in view of the printed products to be produced, can be considerably increased. Often, a further, additional format, which differs from the main format being printed, is also needed for producing varied newspaper-like products in a print shop. Up to now, additional formats, requiring a change in the circumference of the plate cylinder, have been extremely problematical. Customary concepts, known for use in offset technology, cannot be applied in the case of flexographic printing.

The above described possibility of a variable section length also offers the user an economically attractive option of printing a second format without the cutting which is otherwise unavoidable in connection with the same format. The omission of the otherwise arising costs of cutting, including the costs of paper and cutting equipment, can result in an advantageous amortization of the described solution. A second printing press, for use in printing the second format, can possibly be completely omitted, and the printing press that is suitable for two formats can furthermore be operated at particularly high capacity. Because of this, the efficiency of the solution in accordance with the invention is optimized.

In order to be able to match the length of the print sections to a length of a fold section of a folding apparatus 123, which is typically arranged downstream of the printing unit 03, or downstream of the printing tower 01, it is advantageously possible to provide that the section length of the folding apparatus 123 can be changed, because of which a highly efficient production of printed products becomes possible. Examples of a suitable folding apparatus 123, with variable fold section length, such as a folding apparatus 123 which can be placed indirectly or directly downstream of the printing units 03 or of the printing towers 01, will be explained in what follows by means of FIGS. 26 to 29.

An embodiment of a variable folding apparatus 123 with a field system 7:7 is represented in FIG. 26. The type of construction of such a folding apparatus can, for example, also be taken from EP 0 257 390 B1. At the inlet of the imprint material web 02, the folding apparatus has a traction roller pair 124, by the use of which, the imprint material web 02 is electrostatically charged. The imprint material web 02 is initially cut into individual sheets in accordance with the predetermined section length in a downstream located cutting roller pair 126. Acceleration belts 127, with which the individual sheets can be accelerated, are arranged downstream of the cutting roller pair 126. The individual sheets subsequently reach a cylinder 128, in particular a collection cylinder 128 and/or a folding blade cylinder 128, and are there passed on to a folding jaw cylinder 129, which can be provided with springs. In this case, the collection cylinder 128 has two multi-armed fitting supports, which can be displaced with respect to each other. The section length of the cut sheets can be varied during folding by adjusting the two fitting supports.

Electric motors 131, and in particular servo motors 131, which can be controlled independently of other drive arrangements, are provided for driving the various functional elements of the folding apparatus 123. The cylinder portion and the delivery portion of the folding apparatus 123 can be driven independently of each other. Preferably, the cylinder 128 has folding blade systems arranged on fitting supports and also has holding systems, such as, for example, gripper systems or spur needle systems.

Spacing between the holding system and the folding blades of the folding blade cylinder 128, as a function of the diameter of the forme cylinder 06, can be adjusted remotely and can be controlled by a control arrangement.

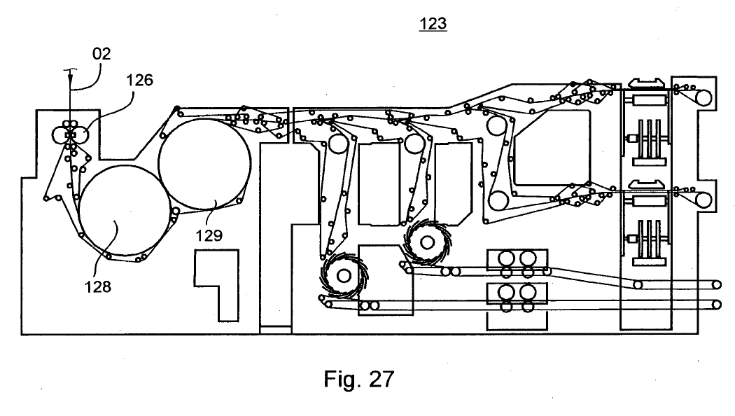

FIG. 27 shows a further embodiment of a folding apparatus 123 which can be employed in printing presses in accordance with the present invention. The folding apparatus 123 is constructed in accordance with the 5:5 field system with a double third fold and with two transverse fold deliveries. A cutting roller pair 126 is also provided at the inlet of this folding apparatus 123. The folding apparatus inlet of the folding apparatus 123 is laid out in such a way that the format adaptation takes place as a function of the section length in letterpress printing by the operation of the cutting cylinder pair 126, which rotates at a fixed rpm ratio with respect to the forme cylinders 06. Depending on the circumferential format, the cutting cylinder pair 126 permits more or less continuous web lengths to pass through the transverse cutting group before the cut is performed.

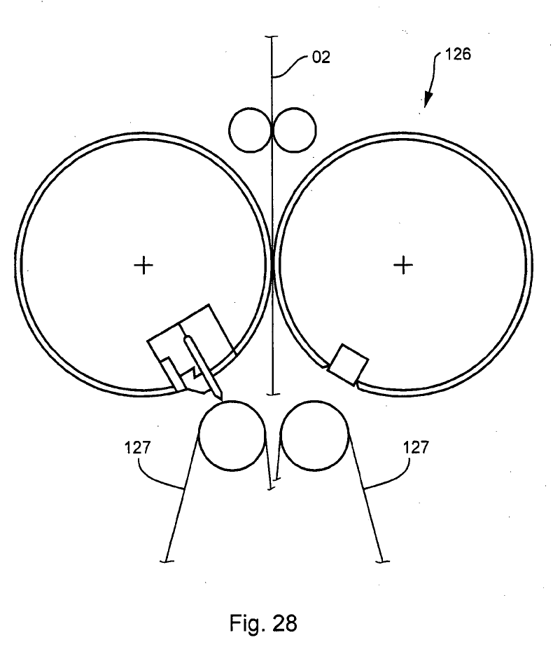

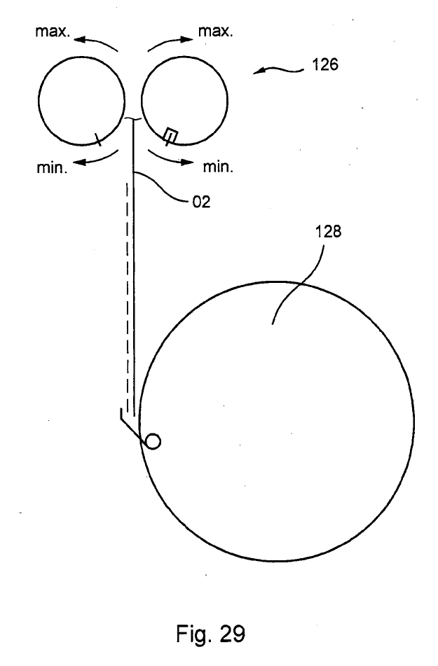

FIGS. 28 and 29 each show a cutting roller pair 126 and with the start of a belt section 127, such as, for example, acceleration belts 127 for use in accelerating the cut sheet to folding speed. In this case, the cutting roller pair 126 can be driven at the clock rate of the forme cylinders 06. Alternatively, or additionally, the cutting cylinder pair 126 can be driven at a predetermined rpm ratio with respect to the number of revolutions of the forme cylinders 06. As a result, it is achieved by this, that the cutting cylinder pair 126 is driven at a predetermined speed independently of the web speed of the imprint material web 02 in order to vary the section length of the folding apparatus 123 in this way.

In accordance with a further advantageous aspect of the present invention, a suction arrangement is assigned to the screen roller 07 of a web-fed rotary printing press, such as, for example, a flexographic printing press.

In connection with the construction of chamber doctor blades, it is necessary, inter alia, to insure that air, which has been introduced into the chamber doctor blade via the emptied small cups of the screen roller, can escape again from the chamber doctor blade, or can be forcibly removed from it. The air, which may be introduced into the chamber doctor blade, forms air cushions under overpressure. These lead to the lift-off of the chamber doctor blade, which has been placed into contact with the screen roller, with a regulated force, from the screen roller. Because of this, a thin ink film is created on the screen roller surface, which, in turn, leads to increasing density values in the printed product.

For example, the ink is pumped into the chamber doctor blade, and the ink is subsequently suctioned off, together with any air which may have been introduced into the chamber doctor blade, via a second pump, which second pump, as a rule, is a compressed air-driven diaphragm pump. The amount of the suctioned-off ink and air mixture is typically twice as large as the pumped-in amount of ink. In order to prevent underpressure, the chamber doctor blade is connected by bores with the air which is introduced into it. It is disadvantageous, in connection with this embodiment, that paper dust particles, which may be torn off the paper web after contact with the printing plate, as well as other particles of dirt, are again conveyed into the chamber doctor blade by the screen roller. These are then mixed with the printing ink in the chamber doctor blade, and are not forcible removed by the suction system. Also, ink which, although it had been pulled out of the small cups of the screen roller during contact with the printing plate, had not been applied to the paper web but was instead conveyed back on the surface of the screen roller, is stripped off by the end doctor blade of the chamber doctor blade and drips off the end doctor blade. This leads to dirt accumulation in the doctor blade system.

It is now proposed, in accordance with the present invention, to suction off the surface of the screen roller 07 prior to the surface of the screen roller 07 entering an inking arrangement which is assigned to the screen roller 07, such as, for example, a chamber doctor blade 08.

By the provision of this screen roller suction, the disadvantages described in connection with the prior art are avoided. Moreover, because of the aspiration of the air out of the small cups of the screen roller, prior to the contact of the screen roller with fresh ink, the filling of the small cups with fresh ink is improved. Additionally, no air-enriched and soiled ink is passed on to the printing plates 27.

Suctioning of the surface of the screen roller 07 is preferably performed in such a way that the suction arrangement constitutes a closed system together with the chamber doctor blade 08. The small screen roller cups which have now been emptied by suction no longer come into contact with the ambient air.

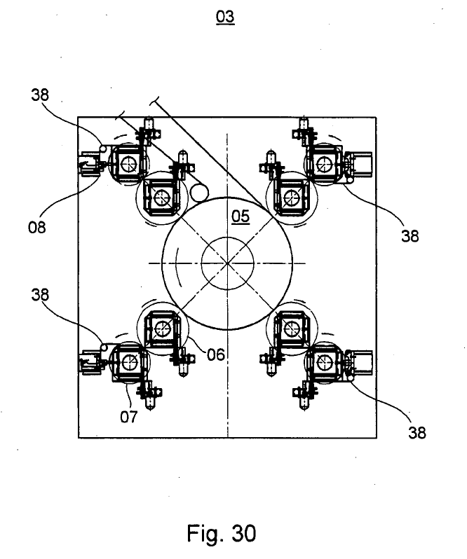

A preferred embodiment of this aspect of the present invention will be explained in greater detail in what follows, making reference to FIGS. 30 to 32.

The printing unit 03 represented in FIG. 30 is constructed, in the present preferred embodiment, the same as the printing unit 03 which was discussed previously in accordance with FIG. 1 or FIG. 2, and to this extent, reference is made to the description there. In addition, in the case of the present invention, a suction arrangement 38 is provided and is identified, as a whole, by the reference numeral 38.

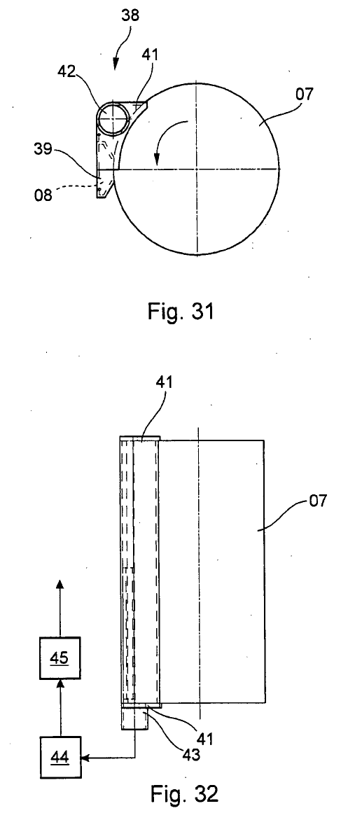

The suction arrangement 38 comprises a hood-like housing 39 which is extending over the entire axial length of the screen roller 07, as seen in FIG. 32 and into which the chamber doctor blade 08 is integrated. Housing or hood 39 extends from the chamber doctor blade 08 in a direction opposite to the direction of rotation of the screen roller 07, as indicated by the arrow in FIG. 31. The housing 39 is open toward the cylindrical surface of the screen roller 07 and is sealed in the axial direction by the provision of lateral sealing walls 41, such as, for example, by a seal 41, with respect to the screen roller 07. The lateral walls 41 of the housing 39 overlap the lateral end walls of the chamber doctor blade 08 and in this way constitute a closed space together with the chamber doctor blade 08.

At least one aspirating opening 42 has been formed in the housing 39. In the case of the preferred embodiment, a single aspirating opening 42 is provided in one of the lateral walls 41, which single aspirating opening 42 is defined by a connecting sleeve 43. This connecting sleeve 43 preferably extends in the axial direction of the screen roller 07, and is usable for connecting a hose or a pipe, which is not specifically represented, for aspirating the mixture of air and ink in the housing 39. The suctioned-off mixture is supplied to an ink tank 44, which is provided with a downstream-connected filter circuit 45, such as, for example, a filter arrangement 45, and the cleaned ink is returned to the printing process. The aspirating opening is preferably oriented axis-parallel with the screen roller 07.

While preferred embodiments of a flexographic printing press, in accordance with the present invention, have been set forth fully and completely hereinabove, it will be apparent to one of skill in the art that various changes in, for example, the supply of the paper webs, the arrangement of the superstructure, and the like could be made without departing from the true spirit and scope of the present invention which is accordingly to be limited only by the appended claims.

What is claimed is:

1-135. (canceled)

136. A flexographic printing press comprising:
at least four forme cylinders, each said forme cylinder having spaced forme cylinder journals and each having an axis of rotation, each said forme cylinder supporting at least one flexographic printing plate;
a separate drive motor for each said forme cylinder, each said drive motor being a synchronous motor with permanent magnet excitation, each said separate drive motor including a stator and a rotor;
a common satellite cylinder adapted to cooperate with said at least four forme cylinders to print a material web using said flexographic printing plates supported on each of said at least four forme cylinders;
at least one lateral frame of said flexographic printing press and having an inner wall;
linear bearings on said inner wall of said at least said one lateral frame and adapted to receive a journal of each said forme cylinder for mounting of each said forme cylinder axis of rotation, said stator of each said forme cylinder being movable together with its associated linear bearing;
a bearing unit arranged on said inner wall of said at least one lateral frame, said linear bearing for each said forme cylinder being arranged in said bearing unit, said journals of said at least four forme cylinder not penetrating through said at least one lateral frame; and
a separate hydraulic actuator for each said forme cylinder and being usable to accomplish a position change of each said forme cylinder.

137. A flexographic printing press comprising:
at least one forme cylinder and supporting at least one flexographic printing plate, said at least one forme cylinder having forme cylinder journals and being rotatable about an axis of rotation;
a screen roller cooperating with said at least one forme cylinder;
a separate angular position-regulated electric motor for said at least one forme cylinder;
a bearing unit for said at least one forme cylinder, said bearing unit including linear bearings and a bearing block, said bearing block being movable in a forme cylinder actuating direction along said linear bearings; and
a radial bearing in said bearing block and adapted to receive said at least one forme cylinder journal, said bearing unit, including said bearing block and said linear bearings being configured as a unitary component and being adapted to be mounted in said flexographic printing press as said unitary component.

138. The flexographic printing press of claim 137 further including at least a first lateral frame having an inner frame wall, said at least one forme cylinder journals not penetrating said at least first lateral frame.

139. The flexographic printing unit of claim 138 and further including a second lateral frame spaced from said first lateral frame at a lateral frame clearance distance, said at least one forme cylinder, including said journals having a frame cylinder distance less than said lateral frame clearance distance.

140. The flexographic printing press of claim 137 further including at least one flexographic printing unit including at least four of said forme cylinder and at least one rotatable cylinder cooperating with said at least four forme cylinders and having a satellite cylinder axis of rotation.

141. The flexographic printing press of claim 140 wherein axes of rotation of two of said at least four forme cylinders and said satellite cylinder are arranged along a common straight line.

142. The flexographic printing press of claim 137 further including a chamber doctor blade cooperating with each said screen roller.

143. The flexographic printing press of claim 140 wherein said at least one satellite cylinder has a satellite cylinder diameter and further including a printed product printed by said flexographic printing unit and having a printed product section length, said satellite cylinder diameter being a whole number multiple of said printed product section length.

144. The flexographic printing press of claim 140 further including a satellite cylinder angular position-regulated electric drive motor.

145. The flexographic printing press of claim 140 wherein each of said at least four forme cylinders has its own one of said angular position regulated electric motor.

146. The flexographic printing press of claim 137 wherein said screen roller for each of said at least one forme cylinders has a screen roller angular position-regulated electric motor.

147. The flexographic printing press of claim 140 further including a linear bearing for each of said at least four forme cylinders.

148. The flexographic printing press of claim 147 wherein each said forme cylinder is movable into engagement with said satellite cylinder along said linear bearing.

149. The flexographic printing press of claim 137 further including a linear bearing for said at least one screen roller.

150. The flexographic printing press of claim 149 wherein said screen roller is movable into engagement with said at least one forme cylinder along said screen roller linear bearing.

151. The flexographic printing press of claim 142 further including a chamber doctor blade linear bearing for each said chamber doctor blade.

152. The flexographic printing press of claim 151 further wherein said chamber doctor blade is movable along said chamber doctor blade linear bearing into engagement with said screen roller.

153. The flexographic printing press of claim 152 further including means for placing said chamber doctor blade against said screen roller in a pressure-regulated manner.

154. The flexographic printing press of claim 149 further including a chamber doctor blade in cooperation with said screen roller and movable with said screen roller to follow a position change of said screen roller.

155. The flexographic printing press of claim 154 wherein a pressure-regulated print-on position of said chamber doctor blade in contact with said screen roller is maintained during said position change of said screen roller.

156. The flexographic printing press of claim 154 further including means for mechanically coupling said chamber doctor blade to said screen roller linear bearings.

157. The flexographic printing press of claim 137 further including a linear guide in said forme cylinder linear bearing and a carriage supported in said linear guide.

158. The flexographic printing press of claim 157 further including a screen roller bearing unit including screen roller linear bearings and a screen roller carriage and a chamber doctor blade bearing unit including chamber doctor blade linear bearings and a chamber doctor blade linear guide, said chamber doctor blade linear guide being connected with said screen roller linear bearing.

159. The flexographic printing press of claim 158 further including a chamber doctor blade linear guide support fastened on said screen roller carriage.

160. The flexographic printing press of claim 158 further including a chamber doctor blade carriage on said chamber doctor blade linear bearings and wherein said chamber doctor blade carriage is connectable with said screen roller carriage in a space variable manner.

161. The flexographic printing press of claim 160 further including a piston-cylinder assembly forming said connection between said chamber doctor blade carriage and said screen roller carriage, said piston-cylinder being adapted to provide said space varying connection.

162. The flexographic printing press of claim 161 wherein a piston of said piston-cylinder assembly is connected with one of said chamber doctor blade carriage and said screen roller carriage and a cylinder of said piston-cylinder assembly is connected with the other of said chamber doctor blade carriage and said screen roller carriage.

163. The flexographic printing press of claim 157 further including a screen roller bearing unit including screen roller linear guides, said forme cylinder linear guides and said screen roller linear guides being parallel.

164. The flexographic printing press of claim 157 further including a screen roller bearing unit including said forme cylinder linear guides.

165. The flexographic printing press of claim 157 further including a screen roller bearing unit including screen roller linear guides and a chamber doctor blade in cooperating with said screen roller and having a chamber doctor blade bearing wall including linear guides, said forme cylinder linear guides, said screen roller linear guides and said chamber doctor blade guides being parallel.

166. The flexographic printing press of claim 165 wherein said forme cylinder bearing guide, said screen roller linear guide and said chamber doctor blade linear guide are a common linear guide.

167. The flexographic printing press of claim 165 wherein at least two adjoining ones of said forme cylinder linear guide, said screen roller linear guide and said chamber doctor blade linear guide are a common linear guide.

168. The flexographic printing press of claim 147 further including at least one actuating member for each said forme cylinder linear bearing.

169. The flexographic printing press of claim 168 wherein each said actuating member is actuatable by pressure.

170. The flexographic printing press of claim 169 wherein said pressure is one of hydraulic and pneumatic.

171. The flexographic printing press of claim 137 further including spaced lateral frames and wherein said frame cylinder bearing unit does not penetrate said lateral frames.

172. The flexographic printing press of claim 171 further including inner frame walls and wherein said bearing units are arranged on said lateral frame inner walls.

173. The flexographic printing press of claim 137 wherein said at least one forme cylinder has a cylinder diameter and further including a bearing means, having a length, in said forme cylinder bearing unit linear bearing, said bearing means length being less than said forme cylinder diameter.

174. The flexographic printing press of claim 137 further including at least one actuator for said forme cylinder bearing unit and usable to position said at least one forme cylinder in a print-on position.

175. The flexographic printing press of claim 174 further including means for limiting a length of an actuating path of said bearing unit in a direction toward said print-on location.

176. The flexographic printing press of claim 175 wherein said means for limiting a length of an actuating path is a detent whose position along said actuating path is variable and which detent is usable to limit said actuating pull in said actuating direction toward each print location.

177. The flexographic printing press of claim 176 further including a detent actuating mechanism in said forme cylinder bearing unit.

178. The flexographic printing press of claim 174 wherein said at least one actuator is adapted to exert a definite force on said forme cylinder bearing unit bearing block.

179. The flexographic printing press of claim 174 wherein said at least one actuator is adapted to be actuated by pressure means of a defined strength.

180. The flexographic printing press of claim 137 wherein said forme cylinder bearing unit includes first and second actuators adapted to apply first and second forces to said bearing block at first and second points of force application, said first and second points of force application being spaced apart from each other in a direction perpendicular to said forme cylinder axis of rotation.

181. The flexographic printing press of claim 173 wherein said forme cylinder bearing unit, which is configured as said unitary component, is removable from said forme cylinder journal and includes a housing with an actuator in said housing.

182. The flexographic printing press of claim 174 wherein said at least one actuator is a piston adapted to be actuated by a pressure medium.

183. The flexographic printing press of claim 137 wherein said forme cylinder bearing unit includes two of said linear bearings configured as linear guides, and including first and second bearing elements adapted to work with each other to form each said linear bearing.

184. The flexographic printing press of claim 183 wherein a first of said bearing elements is fixed in place and a second of said bearing elements is movable and is connected with said bearing block, each of said bearing elements including at least one guide surface.

185. The flexographic printing press of claim 184 wherein each of said first and second bearing elements have at least two of said guide surfaces located at two planes which are inclined with respect to each other.

186. The flexographic printing press of claim 185 wherein said two guide surfaces of each of said bearing elements are inclined at a V-shape toward each other.

187. The flexographic printing press of claim 185 wherein said first and second guide surfaces of each said bearing element are arranged in a complementary shape with respect to guide surfaces of other ones of said bearing elements with which they cooperate.

188. The flexographic printing press of claim 184 wherein said guide surfaces of each said bearing element, which are fixed in place, are directed into a half-space facing said forme cylinder journal.

189. The flexographic printing press of claim 185 wherein said bearing elements which are fixed in place on said frame extend around said bearing block arranged between them.

190. The flexographic printing press of claim 137 wherein an actuating path of said bearing block in a print-off direction of said forme cylinder, is limited by a load dependent, position changeable detent.

191. The flexographic printing press of claim 183 wherein said axis of rotation of said forme cylinder extends between said linear bearings.

192. The flexographic printing press of claim 183 wherein said radial bearing is arranged between said first and second linear bearings.

193. The flexographic printing press of claim 137 wherein said electric motor is one of a synchronous motor and a motor with permanent magnet excitation.

194. The flexographic printing press of claim 193 wherein said synchronous motor has a weakenable field.

195. The flexographic printing press of claim 193 wherein a rotor of said synchronous motor is positioned coaxially to said axis of rotation of said forme cylinder.

196. The flexographic printing press of claim 193 wherein a rotor of said synchronous motor is connected to said forme cylinder in a gearless manner.
